(19) United States
(12) Patent Application Publication
(10) Pub. No.: US 2014/0146562 A1
(43) Pub. Date: May 29, 2014

(54) ILLUMINATION DEVICE AND DISPLAY DEVICE

(71) Applicants: Takeshi Ishida, Osaka-shi (JP); Ryuzo Yuki, Osaka-shi (JP); Yoshitsugu Kawahigashi, Osaka-shi (JP); Ichiro Umekawa, Osaka-shi (JP); Shugo Yagi, Yonago-shi (JP)

(72) Inventors: Takeshi Ishida, Osaka-shi (JP); Ryuzo Yuki, Osaka-shi (JP); Yoshitsugu Kawahigashi, Osaka-shi (JP); Ichiro Umekawa, Osaka-shi (JP); Shugo Yagi, Yonago-shi (JP)

(73) Assignee: Sharp Kabushiki Kaisha, Osaka-shi, Osaka (JP)

(21) Appl. No.: 14/232,136

(22) PCT Filed: Jun. 13, 2012
(86) PCT No.: PCT/JP2012/065106

§ 371 Date: Jan. 10, 2014

(30) Foreign Application Priority Data
Jul. 13, 2011 (JP) 2011-154478

(51) Int. Cl. F21V 8/00

(52) U.S. Cl. CPC G02B 6/0086
USPC 362/606; 362/611

(57) ABSTRACT

A backlight unit comprises a light source, a light guide plate and a frame. The light guide plate comprises a light guide and a low-refractive-index layer. The refractive index of the low-refractive-index layer is less than the refractive index of the light guide. A plurality of prisms for gradually reducing the angle of incidence of light coming from the light source with respect to the rear surface of the light guide are provided to the front surface or rear surface of the light guide. A plurality of prisms for totally reflecting forward the light coming from the light source are provided to the rear surface of the light guide plate. The frame comprises walls for surrounding the light source and the light guide plate. The width of the upper side of the walls and the width of the lower side thereof are substantially equal.

### TECHNICAL FIELD

The present invention relates to an illumination device and a display device; in particular, the present invention relates to an illumination device loaded with a light guide member for guiding light, and a display device provided with the illumination device.

### BACKGROUND ART

Liquid crystal display devices (display devices) loaded with a non-luminous liquid crystal display panel (display panel) normally include a backlight unit (illumination device). The backlight unit supplies light to the liquid crystal display panel.

The backlight unit may in some instances include a light guide plate (light guide member). For example, edge-lit (side-lit) backlight units include a light guide plate. In an edge-lit backlight unit, typically a light source such as a light-emitting diode (LED) is arranged at a side surface of the light guide plate. Light that is emitted from the light source is incident on the light guide plate from the side surface of the light guide plate, and the incident light is guided in the interior of the light guide plate and released to the liquid crystal display panel side.

FIGS. 41 and 42 illustrate an example of a conventional liquid crystal display device (for example, U.S. Patent Application Publication No. 2007/0019127). FIG. 41 is a cross-sectional view of this conventional liquid crystal display device, and FIG. 42 is an enlarged view of a part thereof. As is illustrated in FIGS. 41 and 42, the conventional liquid crystal display device includes a liquid crystal display panel 510 and an edge-lit backlight unit 520.

The backlight unit 520 includes a light guide plate 521 for guiding light, an LED serving as a light source (not shown), an optical sheet group 522 made of a plurality of optical sheets, and a reflective sheet 523. The backlight unit 520 also includes a frame-shaped resin mold frame (accommodation member) 525 for accommodating the light guide plate 521 and the like. The reflective sheet 523 is affixed to the rear surface of the resin mold frame 525 with a double-sided tape 530. The light guide plate 521, the optical sheet group 522, and the liquid crystal display panel 510 are arranged inside the resin mold frame 525.

The resin mold frame 525 has a first stepped part 525a and a second stepped part 525b. The first stepped part 525a supports the optical sheet group 522, and the second stepped part supports the liquid crystal display panel 510. The optical sheet group 522 and the liquid crystal display panel 510 are fixed to the resin mold frame 525 by the double-sided tape 531.

As is illustrated in FIG. 42, the frame width W of the resin mold frame 525, the width W1 of the bottom surface of the first stepped part 525a, the width W2 of the bottom surface of the second stepped part 525b, and the width W3 of the upper surface of the resin mold frame 525 are such that W=W1+W2+W3. The width W1 is the width necessary in order to fix the optical sheet group 522, and the width W2 is the width necessary in order to have ample bonding strength in fixing the liquid crystal display panel 510 and the backlight unit 520 (the resin mold frame 525) together. The width W3 is the width necessary in order to prevent the leakage of light out from the backlight unit 520.

Here, a region S101 of the resin mold frame 525 contributes to light blocking and fixation of the light guide plate 521, a region S102 contributes to light blocking and fixation of the optical sheet group 522, and a region S103 contributes to light blocking and fixation of the liquid crystal display panel 510.

### SUMMARY OF INVENTION

### Technical Problem

With such a liquid crystal display device, the stepped resin mold frame 525 is used in order to prevent the leakage of light (see the arrows in FIG. 42) from the backlight unit 520 and in order to support the optical sheet group 522 and the like. Therefore, the frame width W (=W1+W2+W3) of the resin mold frame 525 is very large. Furthermore, the portion in the liquid crystal display device where the resin mold frame 525 is arranged is non-display regions A2 and A3 that are not used for display (see FIG. 41). In the conventional backlight unit 520, the non-display regions A2 and A3 are very large, resulting in a larger frame width. It is difficult to reduce the scale of equipment while also increasing the display region A1.

Moreover, in the conventional backlight unit 520, a plurality of optical sheets are used, resulting in a greater thickness of the backlight unit 520. It is therefore difficult to achieve reduced thickness. The steps of assembly are also more complicated because there are many optical sheets.

### Solution to Problem

In order to solve the aforementioned problems, a first objective of the present invention is to provide an illumination device and display device making it possible to achieve a narrower frame width. Another objective of the present invention is to provide an illumination device and display device making it possible to achieve a reduced size and reduced thickness. Yet another objective of the present invention is to provide an illumination device and display device making it possible to facilitate the steps of assembly.

In order to achieve the objectives described above, an illumination device of the present invention comprises a light source, a light guide member for guiding light coming from the light source, and an accommodation member for accommodating the light source and the light guide member. The light guide member comprises a light guide onto which the light coming from the light source is incident, and a low-refractive-index layer provided on a rear surface of the light guide. The refractive index of the low-refractive-index layer is lower than the refractive index of the light guide. A plurality of first reflective parts for gradually reducing the angle of incidence of the light coming from the light source with respect to the rear surface of the light guide are provided to a front surface of the light guide or the rear surface thereof. A plurality of second reflective parts for reflecting forward the light coming from the light source are provided to the rear surface of the light guide member. The accommodation member comprises walls surrounding the light source and the light guide member. The width of an upper side of the walls and the width of a lower side thereof are equal (substantially equal).

In the illumination device, the light coming from the light source is guided while being repeatedly reflected between a portion on the front surface side of the light guide and the rear surface, and the angle of incidence of the light with respect to the rear surface of the light guide is gradually reduced. The light coming from the light source is incident on the low-refractive-index layer in a case where the angle of incidence of the light with respect to the rear surface of the light guide is less than a critical angle between the light guide and the low-refractive-index layer. For this reason, the light that is incident on the low-refractive-index layer has a smaller angle of spreading of light, and also the angle of spreading of light that is reflected at the interface between the rear surface of the light guide member and an air layer is smaller. This makes it possible to reduce the angle of spreading of the light emitted from the light guide member, and therefore makes it possible to improve the light-condensing properties. In addition, the brightness can also be improved.

It is further possible to improve the light-condensing properties and brightness without providing a plurality of optical sheets, such as condensing lenses, on the light guide member. There is accordingly no need to provide optical sheets. For this reason, it is possible to reduce the thickness and lower the costs of production of the illumination device. Also, there is no loss of light on passing through the optical sheets (for example, there is no light loss caused by multiple reflections between sheets), and thus it is possible to improve the efficiency of utilization of light.

The light coming from the light source is guided while being repeatedly reflected between the portion on the front surface side of the light guide and the rear surface, and as the distance from the light source increases, the angle of incidence of the light with respect to the rear surface of the light guide decreases. For this reason, as the distance from the light source increases, the light coming from the light source is more readily incident on the low-refractive-index layer. For this reason, it is possible to have a uniform amount of light incident on the low-refractive-index layer at a portion close to the light source, where there is a large amount of light (light flux), and a portion far away from the light source, where there is less light (light flux). As a result, the light can be uniformly emitted from the light guide member. In addition, uniform brightness can also be obtained.

The second reflective parts also make it possible to uniformly reflect the light. This makes it possible to suppress the occurrence of dot unevenness, and also makes it possible to obtain more uniform brightness. Here, it is preferable for the second reflective parts to be provided to substantially the entire rear surface of the light guide member (to a portion corresponding to at least the entire light emission region). The light can be more uniformly emitted from the entire (substantially the entire) light emission region of the light guide member.

The plurality of second reflective parts have the function of reflecting the light coming from the light source. The light that is incident on the low-refractive-index layer from the light guide is emitted from the rear surface of the light guide member, and the occurrence of loss of light can be suppressed. Because the second reflective parts reflect the light, absorption of the light at the second reflective parts is suppressed. This makes it possible to further improve the efficiency of utilization of light.

Thus, the illumination quality can be improved without providing optical sheets (an optical sheet group). For this reason, there is no need to provide to the accommodation member a stepped part for supporting and fixing the optical sheets (optical sheet group). The width of the walls of the accommodation member can be reduced by a commensurate amount. With this configuration, it is also possible to suppress the leakage of light in the lateral direction. Accordingly, there is no need to provide a region for light-blocking to the walls of the accommodation member. It is possible to eliminate the region for supporting the optical sheets and the region for light-blocking in the accommodation member. This makes it possible to cause the width of the walls of the accommodation member to be equal (substantially equal) at the lower side and upper side. As a result, the width of the walls of the accommodation member can be reduced and the frame width can be narrowed. In a case where, for example, a display device comprises the illumination device, it is possible to reduce the scale of the equipment while also increasing the display region. In addition, the design performance and freedom of design can be improved. Furthermore, because there is no need to provide the optical sheets (optical sheet group), the steps for assembling (assembly) can be simplified.

Preferably, the accommodation member is formed in a frame shape. In such a case, more preferably, the cross-section of the walls of the accommodation member is a quadrangular (substantially quadrangular) shape. This makes it possible to readily obtain a smaller, thinner illumination device of a successfully narrowed frame width.

Preferably, the height of the walls of the accommodation member is equal (substantially equal) to the thickness of the light guide member. This makes it possible to effectively reduce the thickness of the illumination device.

Preferably, the accommodation member is constituted of a light-blocking resin material. This makes it possible to effectively suppress the leakage of light in the lateral direction, and also makes it easy to narrow the frame width. The accommodation member may be constituted of a material other than a light-blocking resin material, however.

The illumination device may be further provided with a diffusion sheet that is overlapped by the light guide member. The light that is emitted from the light guide member is scattered on passing through the diffusion sheet. Accordingly, it is possible to obscure any unevenness in brightness. With the diffusion sheet, warping or displacement of the sheet or the like causes less of an impact on the properties than would another optical sheet such as a prism sheet. For this reason, it is still possible to facilitate the steps of assembling (assembly) with a configuration provided with a diffusion sheet.

In such a case, preferably, the diffusion sheet has protrusions that protrude outward as seen in plan view, and the walls of the accommodation member have notches into which the protrusions of the diffusion sheet are fitted. It is possible to support the diffusion sheet without increasing the width of the walls of the accommodation member. Accordingly, it is still easy to narrow the frame width with a configuration provided with a diffusion sheet.

Preferably, the diffusion sheet is of the size equal (substantially equal) to that of the light guide member.

In a case where the accommodation member is formed in a frame shape, the illumination device may be further provided with a reflective sheet that is disposed on the rear surface side of the light guide member. Preferably, the frame-shaped accommodation member has an opening in the middle, and the reflective sheet is arranged so as to cover the opening of the accommodation member.

A display device of the present invention is provided with the above-described illumination device, and a display panel for receiving the light coming from the illumination device. Accordingly, it is easy to obtain a smaller, thinner display device that has excellent display quality and a successfully narrowed frame width.

### Advantageous Effects of the Invention

As described above, according to the present invention, it is easy to obtain an illumination device and display device making it possible to achieve a narrower frame width. It is also easy to obtain an illumination device and display device making it possible to reduce the size and reduce the thickness. It is moreover easy to obtain an illumination device and display device making it possible to facilitate the steps of assembly.

### BRIEF DESCRIPTION OF DRAWINGS

FIG. 1 is a side view of a liquid crystal display device provided with a backlight unit according to a first embodiment of the present invention;

FIG. 2 is a perspective view schematically illustrating the backlight unit according to the first embodiment of the present invention;

FIG. 3 is an exploded perspective view of the liquid crystal display device provided with the backlight unit according to the first embodiment of the present invention;

FIG. 4 is a perspective view schematically illustrating the backlight unit according to the first embodiment of the present invention;

FIG. 5 is a cross-sectional view schematically illustrating the backlight unit according to the first embodiment of the present invention (a view corresponding to the cross-section taken along line V-V in FIG. 10), and is also an optical path diagram illustrating an optical path for light;

FIG. 6 is an enlarged cross-sectional view illustrating the structure of a light emission surface of a light guide of the backlight unit according to the first embodiment of the present invention;

FIG. 7 is a cross-sectional view schematically illustrating the backlight unit according to the first embodiment of the present invention;

FIG. 8 is an enlarged cross-sectional view illustrating the structure of a rear surface side of a light guide plate of the backlight unit according to the first embodiment of the present invention, and is also an optical path diagram illustrating an optical path for light;

FIG. 9 is a perspective view illustrating the backlight unit according to the first embodiment of the present invention (a view of a state before a liquid crystal panel is installed);

FIG. 10 is a plan view illustrating the backlight unit according to the first embodiment of the present invention;

FIG. 11 is a cross-sectional view taken along the XI-XI line in FIG. 10;

FIG. 12 is a cross-sectional view schematically illustrating the liquid crystal display device provided with the backlight unit according to the first embodiment of the present invention (a view corresponding to the cross-sectional view of FIG. 11);

FIG. 13 is a cross-sectional view illustrating an enlarged part of the liquid crystal display device provided with the backlight unit according to the first embodiment;

FIG. 14 is a cross-sectional view taken along the XIV-XIV line in FIG. 3;

FIG. 15 is a cross-sectional view schematically illustrating the backlight unit according to the first embodiment of the present invention, and is also an optical path diagram illustrating an optical path for light;

FIG. 16 is a perspective view for describing the spreading of light that is incident on the light guide of the backlight unit according to the first embodiment of the present invention;

FIG. 17 is a view, from an LED side, of light that is incident on the light guide of the backlight unit according to the first embodiment of the present invention;

FIG. 18 is a view, from the LED side, of light that is incident on a low-refractive-index layer out of the light that is incident on the light guide of the backlight unit according to the first embodiment of the present invention;

FIG. 19 is a drawing illustrating light that is reflected by flat parts 23h and prisms 23i of the light guide of the backlight unit according to the first embodiment of the present invention;

FIG. 20 is a drawing illustrating the light that is reflected by the flat parts 23h of the light guide of the backlight unit according to the first embodiment of the present invention;

FIG. 21 is a drawing illustrating the light that is reflected by the prisms 23i of the light guide of the backlight unit according to the first embodiment of the present invention;

FIG. 22 is a plan view illustrating a backlight unit according to a second embodiment of the present invention;

FIG. 23 is a cross-sectional view taken along line XXIII-XXIII in FIG. 22;

FIG. 24 is a plan view of a diffusion sheet provided to the backlight unit according to the second embodiment of the present invention;

FIG. 25 is a cross-sectional view taken along line XXV-XXV in FIG. 22;

FIG. 26 is a perspective view illustrating a part of a frame of the backlight unit according to the second embodiment of the present invention;

FIG. 27 is a perspective view illustrating the backlight unit according to the second embodiment of the present invention (a view of a state in which a light guide plate, LED, and the like are omitted);

FIG. 28 is a plan view illustrating an enlarged part of the backlight unit according to the second embodiment of the present invention (a view illustrating a state where the diffusion sheet has been attached to the frame);

FIG. 29 is a plan view illustrating an enlarged part of the backlight unit according to the second embodiment of the present invention (a view illustrating a state where the diffusion sheet has been attached to the frame and thereafter fixed with an adhesive layer);

FIG. 30 is a cross-sectional view schematically illustrating the backlight unit according to the second embodiment of the present invention (a view corresponding to a cross-section taken along the XXX-XXX line in FIG. 22);

FIG. 31 is a cross-sectional view schematically illustrating a backlight unit according to a third embodiment of the present invention;

FIG. 32 is an enlarged cross-sectional view illustrating the structure of a light emission surface of a light guide of the backlight unit according to the third embodiment of the present invention;

FIG. 33 is a cross-sectional view schematically illustrating a backlight unit according to a first modification example of the present invention;

FIG. 34 is a cross-sectional view schematically illustrating a backlight unit according to a second modification example of the present invention;

FIG. 35 is a cross-sectional view schematically illustrating a backlight unit according to a third modification example of the present invention;

FIG. 36 is a cross-sectional view schematically illustrating a backlight unit according to a fourth modification example of the present invention;

FIG. 37 is a cross-sectional view schematically illustrating a backlight unit according to a fifth modification example of the present invention;

FIG. 38 is a perspective view illustrating a part of a frame of a backlight unit according to a modification example of the second embodiment;

FIG. 39 is a plan view illustrating an enlarged part of the backlight unit according to the modification example of the second embodiment (a view illustrating a state where the diffusion sheet has been attached to the frame);

FIG. 40 is a plan view illustrating an enlarged part of the backlight unit according to the modification example of the second embodiment (a view illustrating a state where the diffusion sheet has been attached to the frame and thereafter fixed with an adhesive layer);

FIG. 41 is a cross-sectional view illustrating a liquid crystal display device according to a conventional example; and

FIG. 42 is a cross-sectional view illustrating the liquid crystal device according to the conventional example (a view illustrating an enlarged part thereof).

### DESCRIPTION OF EMBODIMENTS

Embodiments embodying the present invention shall be described below on the basis of the accompanying drawings. The embodiments describe examples in which the present invention has been applied to a liquid crystal display device being used as a display unit of a portable machine such as a portable terminal.

### First Embodiment

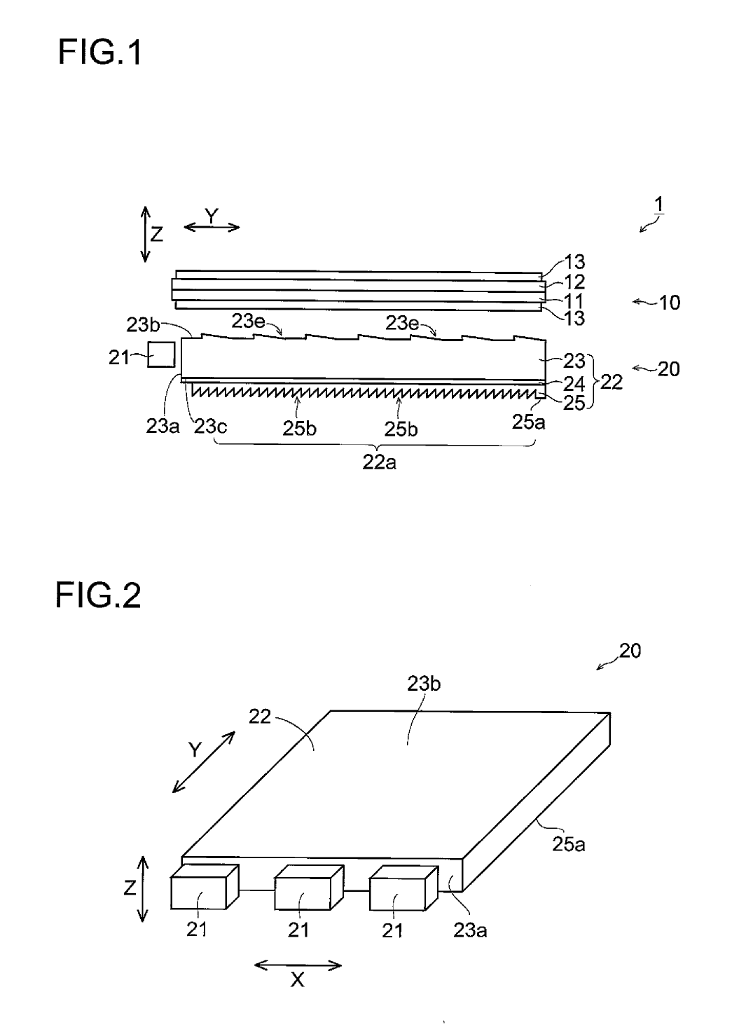

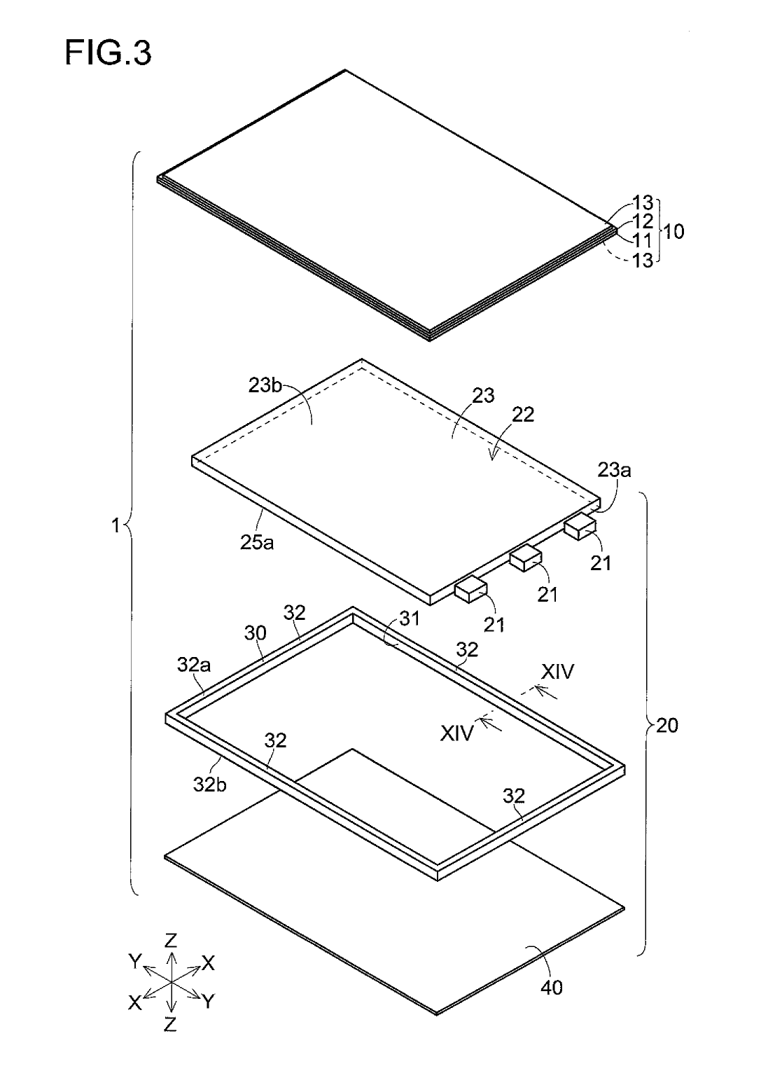

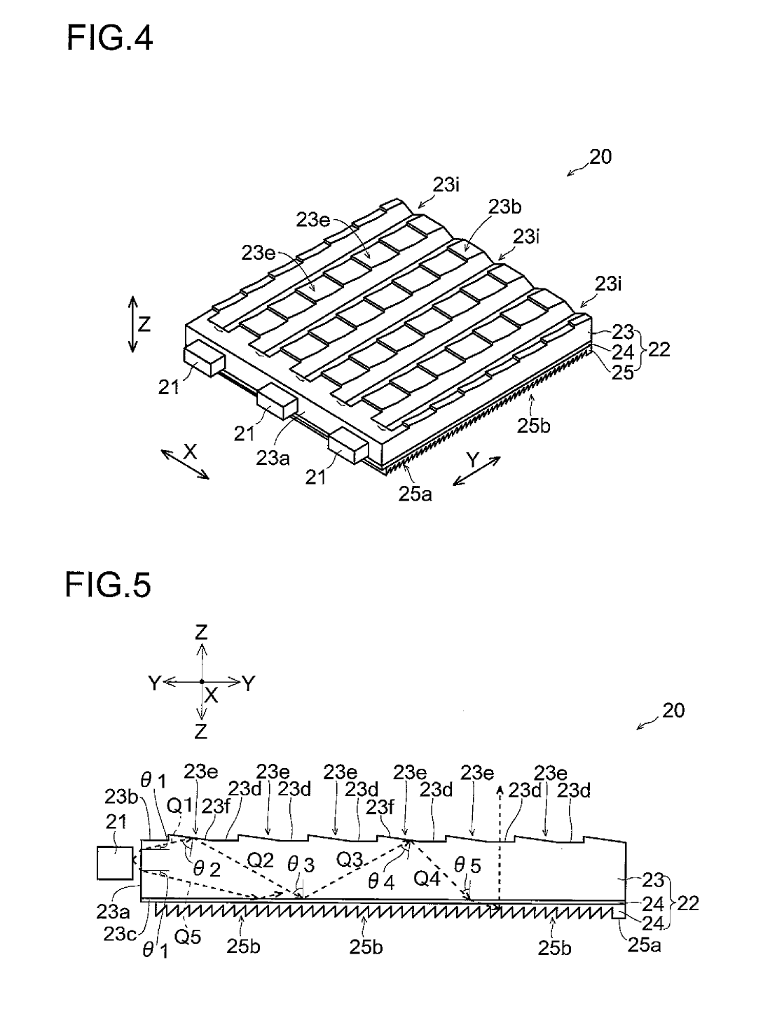

A backlight unit of a first embodiment of the present invention and a liquid crystal display device provided with the backlight unit shall be described on the basis of FIGS. 1 to 21 and FIG. 42. FIG. 1 is a side view of the liquid crystal display device provided with the backlight unit of the first embodiment of the present invention. FIG. 2 is a perspective view schematically illustrating the backlight unit of the first embodiment of the present invention. FIG. 3 is an exploded perspective view of the liquid crystal display device provided with the backlight unit of the first embodiment of the present invention. FIGS. 4 to 21 are drawings for describing the backlight unit of the first embodiment of the present invention.

A liquid crystal display device 1 of the first embodiment, as illustrated in FIG. 1, comprises a liquid crystal display panel 10 and a backlight unit 20 arranged on a rear surface side of the liquid crystal display panel 10.

The liquid crystal display panel 10 comprises an active matrix substrate 11, and an opposing substrate 12 that opposes the active matrix substrate 11. The active matrix substrate 11 comprises switching elements such as, for example, thin film transistors (TFTs). The active matrix substrate 11 and the opposing substrate 12 are pasted together with a sealant (not shown). A liquid crystal (not shown) is injected into a gap between the active matrix substrate 11 and the opposing substrate 12. Polarizing films 13 are attached onto a light-receiving surface side of the active matrix substrate 11 and an emission surface side of the opposing substrate 12.

The liquid crystal display panel 10 uses changes in transmittance caused by the inclination of the liquid crystal molecules to display an image.

The backlight unit 20 of the first embodiment is an edge-lit backlight unit. As illustrated in FIGS. 1 to 3, the backlight unit 20 comprises a plurality of light-emitting diodes (LEDs) 21 serving as a light source, a light guide plate 22 for guiding the light coming from the LEDs 21, a frame 30 for accommodating the LEDs 21 and the light guide plate 22, and a reflective sheet 40 that is disposed on a rear surface side of the light guide plate 22. The plurality of LEDs 21 are arranged so as to be aligned side by side in an X direction (the width direction of the light guide plate 22).

In the backlight unit 20, as illustrated in FIG. 1, there is no condensing lens or other optical sheet (for example, a prism sheet or the like) arranged between the light guide plate 22 and the liquid crystal display panel 10. That is to say, the backlight unit 20 of the first embodiment is a backlight unit having few sheets (called a “sheetless backlight”).

The light guide plate 22 is composed of one planar member. As illustrated in FIGS. 1 and 4, the light guide plate 22 comprises a light guide 23, a low-refractive-index layer 24, and a prism layer 25. The light guide 23 has a light incidence surface (light entrance surface) 23a on which light coming from the LEDs 21 is incident. The refractive index of the low-refractive-index layer 24 is lower than the refractive index of the light guide 23. The prism layer 25 is disposed on a rear surface side of the low-refractive-index layer 24. The light guide 23 is composed of a transparent material of a refractive index n1, the low-refractive-index layer 24 is composed of a transparent material of a refractive index n2, and the prism layer 25 is composed of a transparent material of a refractive index n3.

The refractive index n1 of the light guide 23 is preferably 1.42 or higher, more preferably 1.59 to 1.65. On the other hand, the refractive index n2 of the low-refractive-index layer 24 is preferably less than 1.42, more preferably 1.10 to 1.35. The relationship between the refractive index n1 of the light guide 23 and the refractive index n2 of the low-refractive-index layer 24 is n2<n1. The relationship between the refractive index n1 of the light guide 23 and the refractive index n2 of the low-refractive-index layer 24 is preferably n1/n2>1.18.

The light guide 23 is constituted of, for example, a transparent resin material such as an acrylic or polycarbonate. When the light guide 23 is constituted of an acrylic or the like, the refractive index of the light guide 23 can be set to about 1.49. When the light guide 23 is constituted of a polycarbonate or the like, the refractive index of the light guide 23 can be set to about 1.59. In a case where the light guide 23 is constituted of an acrylic, the translucency can be better than when the light guide 23 is constituted of a polycarbonate.

The light guide 23 is formed so as to be a rectangular parallelepiped (substantially rectangular parallelepiped). That is to say, a light emission surface 23b (an upper surface) and a rear surface 23c (a lower surface) are parallel (substantially parallel). The light incidence surface 23a of the light guide 23 is arranged so as to be parallel (substantially parallel) with the light emission surface of the LEDs 21. The light incidence surface 23a is a side surface of the light guide 23.

The X direction is the width direction of the light guide plate 22, i.e., the lateral direction of the light guide 23. A Y direction is the length direction of the light guide plate 22, i.e., the longitudinal direction of the light guide 23. The Y direction is orthogonal to the X direction. A Z direction is the thickness direction of the light guide 23 (light guide plate 22). The Z direction is orthogonal to the X direction and to the Y direction.

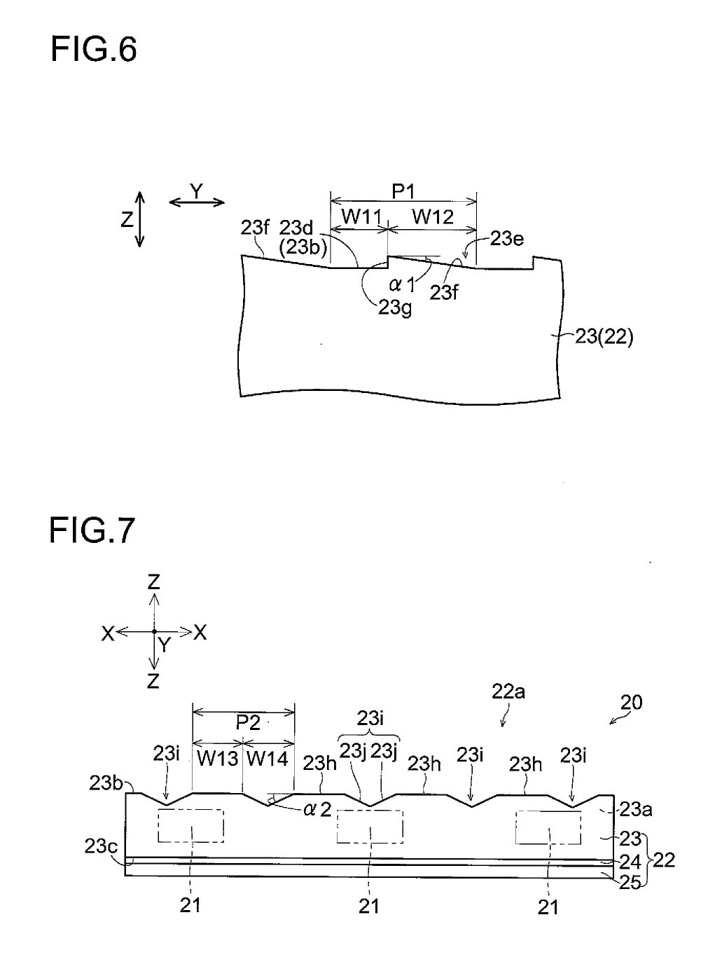

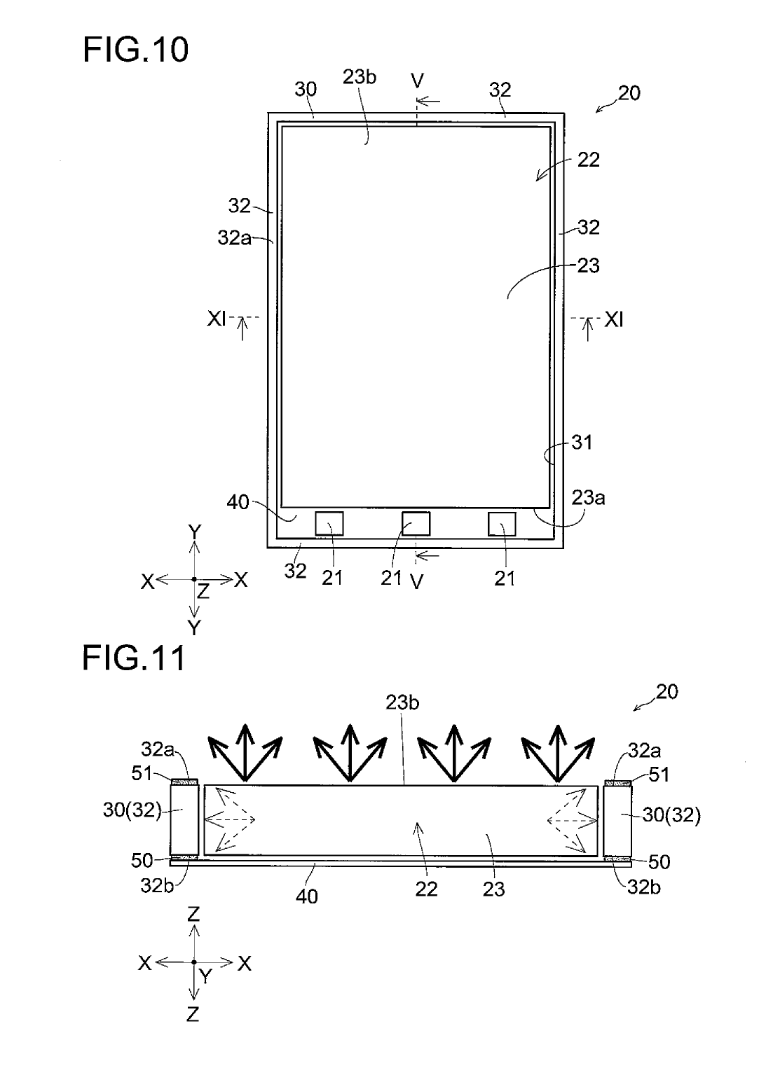

FIG. 5 is a drawing corresponding to a cross-section taken along the V-V line in FIG. 10, and illustrates the LEDs 21 and the light guide plate 22. FIG. 6 is a partially enlarged view of FIG. 5. FIG. 10 is a plan view illustrating the backlight unit of the first embodiment.

The low-refractive-index layer 24, as illustrated in FIG. 5, is formed integrally on the rear surface 23c of the light guide 23, without the interposition therebetween of an air layer or the like. The thickness of the low-refractive-index layer 24 is, for example, about 10 μm to about 50 μm.

As examples, a fluorine-based acrylate, a resin containing nanosized hollow particles such as an inorganic filler, or the like is used for the low-refractive-index layer 24. When the low-refractive-index layer 24 is constituted of a fluorine-based acrylate or the like, the refractive index of the low-refractive-index layer 24 can be set to about 1.35. When the low-refractive-index layer 24 is constituted of a resin containing nanosized hollow particles such as an inorganic filler or the like, the refractive index of the low-refractive-index layer 24 can be set to 1.30 or lower.

The prism layer 25 is formed on the lower surface (rear surface) of the low-refractive-index layer 24 without an air layer or the like interposed therebetween. That is to say, the light guide 23 and the prism layer 25 sandwich the low-refractive-index layer 24. The relationship between the refractive index n3 of the prism layer 25 and the refractive index n2 of the low-refractive-index layer 24 is n3≧n2.

In the first embodiment, a plurality of prisms 23e are formed on the light emission surface 23b of the light guide 23. The prisms 23e gradually reduces the angle of incidence of the light coming from the LEDs 21 with respect to the rear surface 23c of the light guide 23.

More specifically, as illustrated in FIGS. 4 and 5, a plurality of flat parts 23d and the plurality of prisms 23e, which are convex, are formed on the light emission surface 23b alternately along the normal direction (Y direction) of the light incidence surface 23a. That is to say, the flat parts 23d are formed between prisms 23e that are adjacent to each other in the Y direction. The flat parts 23d and the prisms 23e are formed so as to extend in the X direction. The flat parts 23d and the prisms 23e are, however, isolated from one another by prisms 23i (described below).

The flat parts 23d are formed so as to be in the same plane as the light emission surface 23b, and are formed so as to be parallel (substantially parallel) to the rear surface 23c. As illustrated in FIG. 6, the flat parts 23d have a predetermined width W11 in the Y direction.

The convex prisms 23e are formed of inclined surfaces 23f and perpendicular surfaces 23g. The inclined surfaces 23f are inclined with respect to the flat parts 23d (the light emission surface 23b), and the perpendicular surfaces 23g are perpendicular (substantially perpendicular) to the flat parts 23d (the light emission surface 23b). The inclined surfaces 23f are formed so that the inclined surfaces 23f that are increasingly far away from the LEDs 21 are increasingly close to the rear surface 23c, as illustrated in FIG. 5.

As will be described below, the light that is emitted from the LEDs 21 is repeatedly reflected between the inclined surfaces 23f (the prisms 23e) and the rear surface 23c of the light guide 23. As a result, the angle of incidence with respect to the rear surface 23c of the light guide 23 gradually decreases. An angle of incline α1 of the inclined surfaces 23f with respect to the flat parts 23d (see FIG. 6) is preferably 5° or less, more preferably 0.1° to 3.0°.

The inclined surfaces 23f (prisms 23e) have a predetermined width W12 in the Y direction. The width W12 is preferably 0.25 mm or less, more preferably 0.01 to 0.10 mm. The inclined surfaces 23f (prisms 23e) are arranged at a predetermined pitch P1 (=W11±W12) in the Y direction.

The width W11, the angle of incline α1, the width W12, and the pitch P1 may be constant irrespective of the distance from the LEDs 21.

As illustrated in FIG. 7, in the first embodiment, a plurality of flat parts 23h and the plurality of prisms 23i (third reflective parts), which are concave, are formed on the light emission surface 23b of the light guide 23 alternately along the X direction. That is to say, the flat parts 23h are formed between prisms 23i that are adjacent to each other along the X direction. The flat parts 23h and the prisms 23i are formed so as to extend in the normal direction (Y direction) of the light incidence surface 23a of the light guide 23. More specifically, the flat parts 23h and the prisms 23i (inclined surfaces 23j) are formed so as to extend in a direction (the Y direction) perpendicular (substantially perpendicular) with respect to the light incidence surface 23a as seen in plan view.

The flat parts 23h are formed so as to be in the same plane as the light emission surface 23b. The flat parts 23h have a predetermined width W13 in the X direction. The width W13 is preferably 200 μm or less.

The concave prisms 23i are formed of pairs of inclined surfaces 23j that are inclined with respect to the flat parts 23h (the light emission surface 23b). That is to say, the concave prisms 23i are formed so that the cross-section thereof has a triangular shape. An angle of incline α2 of the pairs of inclined surfaces 23j (angle of incline with respect to the flat parts 23h) is preferably about 30° to 89°.

The pairs of inclined surfaces 23j (prisms 23i) have a predetermined width W14 in the X direction. The width W14 is preferably about 0.1 mm or less, more preferably about 0.010 mm (10 μm) to about 0.020 mm (20 μm).

The prisms 23i are arranged at a predetermined pitch P2 (=W13+W14) in the X direction. Preferably, the following relationship holds: P2<W14×2(W13/W14<1). That is to say, the width W13 is preferably less than the width W14.

Preferably, the prisms 23i are formed at the same shape, the same size, and the same pitch irrespective of the positions of formation in the plane of the light guide 23. That is to say, preferably, the width W13, the angle of incline α2, the width W14, and the pitch P2 are each formed so as to be constant.

Thus, in the first embodiment, the prisms 23i are formed on the same plane as the prisms 23e so as to overlap with the prisms 23e (the prisms 23e and the prisms 23i are formed on the light emission surface 23b of the light guide 23). The prisms 23i have the function of diffusing the light in the lateral direction (the direction intersecting the direction of incidence of light, i.e., the X direction). Preferably, the ratio of surface area occupied by the prisms 23i with respect to the prisms 23e is 50% or greater.

As illustrated in FIGS. 1 and 4, a plurality of concave prisms 25b are formed on the rear surface 25a of the prism layer 25 (the rear surface of the light guide plate 22). The prisms 25b are formed on at least an entire light emission region 22a of the light guide plate 22 (see FIG. 1). The prisms 25b are formed so as to extend in the X direction (see FIG. 4). The light emission region 22a of the light guide plate 22 is arranged so as to correspond to a display region of the liquid crystal display panel 10.

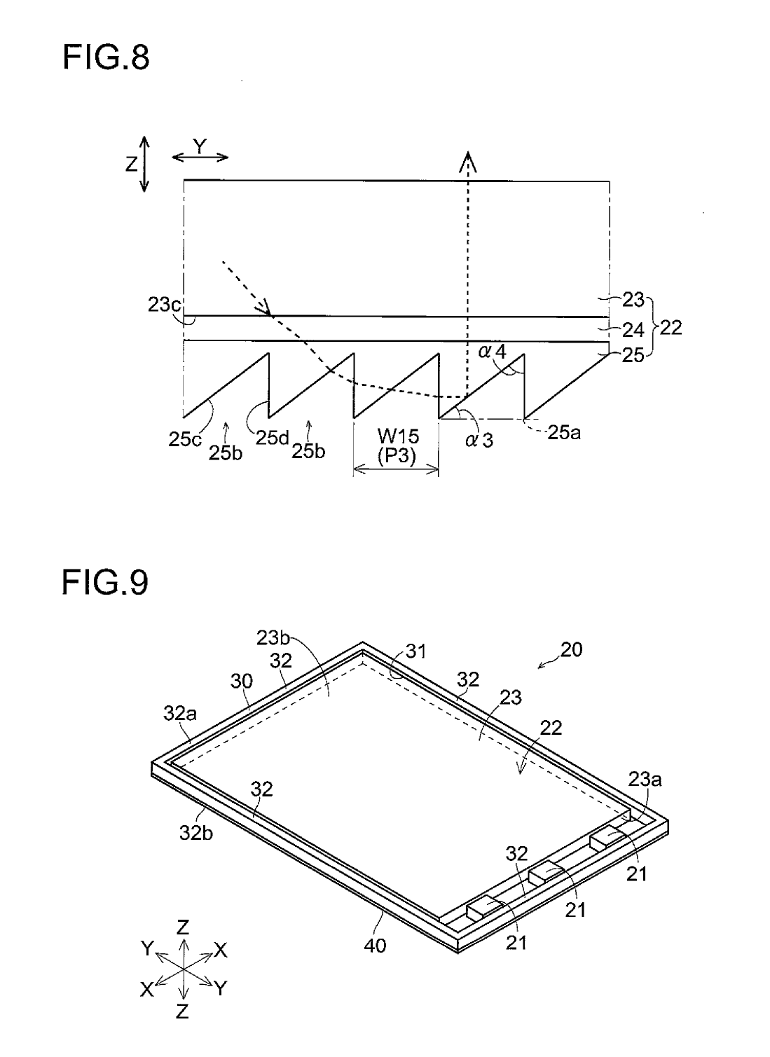

The concave prisms 25b, as illustrated in FIG. 8, are formed of inclined surfaces 25c that are inclined with respect to the rear surface 25a, and perpendicular surfaces 25d that are perpendicular with respect to the rear surface 25a.

In the first embodiment, the inclined surfaces 25c are formed so as to be flat, not curved. The inclined surfaces 25c are formed so that the inclined surfaces 25c that are increasingly far away from the LEDs 21 (see FIG. 1) are increasingly close to the light guide 23. Here, preferably, an angle of incline α3 of the inclined surfaces 25c with respect to the rear surface 25a is about 40° to about 50°. That is to say, preferably, an angle α4 formed by the inclined surfaces 25c and the perpendicular surfaces 25d is about 50° to about 40°.

The inclined surfaces 25c (prisms 25b) have a predetermined width W15 in the Y direction. The width W15 is about 0.1 mm or less, preferably about 0.010 mm to about 0.025 mm.

The inclined surfaces 25c (prisms 25b) are arranged at a pitch P3, the same as the width W15, in the Y direction. That is to say, the plurality of prisms 25b are formed continuously without a gap in the Y direction, and no flat parts are provided between each of the prisms 25b.

The prisms 25b may be formed at the same shape, the same size, and the same pitch on substantially the entire rear surface 25a of the prism layer 25 (at least a portion corresponding to the entire light emission region 22a) irrespective of the positions of formation in the plane of the prism layer 25. It is possible to suppress any difference in the properties of condensing of light in the plane of the prism layer 25. This makes it possible to obtain uniform brightness of the liquid crystal display panel 10 (see FIG. 1).

As described below, the prisms 25b have the function of totally reflecting forward (to the upper surface) the light coming from the LEDs 21 at the interface between the light guide plate 22 and an air layer.

The frame 30 is a resin molded frame and is constituted of, for example, a PET resin. The frame 30 is formed so as to have a frame shape, as illustrated in FIG. 3. That is to say, the frame 30 has no bottom. For this reason, the frame 30 has an opening 31 at the middle. As illustrated in FIGS. 9 and 10, the LEDs 21 and the light guide plate 22 are arranged inside the frame 30.

As illustrated in FIGS. 3, 9, and 10, the frame 30 has walls (frame parts) 32 surrounding the LEDs 21 and the light guide plate 22. The walls 32 (the frame 30) are integrally formed in a rectangular (substantially rectangular) shape, as seen in plan view. Preferably, the frame 30 is constituted of a light-blocking resin material. For example, the frame 30 is preferably a black light-blocking frame. The frame 30 may, however, also be constituted of a material other than a light-blocking resin material. For example, the frame 30 may be constituted of a white resin or the like.

A reflective sheet 40 is formed of a reflective sheet constituted of a dielectric multilayer mirror, a reflective sheet coated with silver, or a reflective sheet composed of a white PET resin. The configuration of the reflective sheet 40 is not particularly limited to the above configuration. The reflective sheet 40 is arranged on the rear surface side of the light guide plate 22 and prevents the loss of light, causing light that has leaked from the rear surface of the light guide plate 22 to be reflected so as to return to the light guide plate 22.

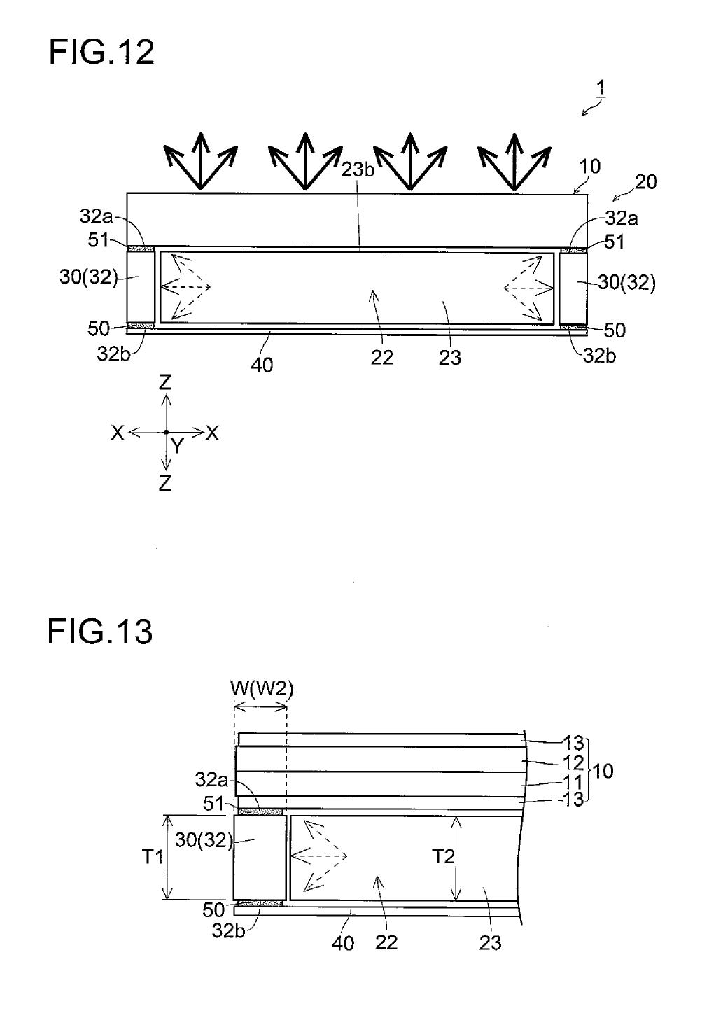

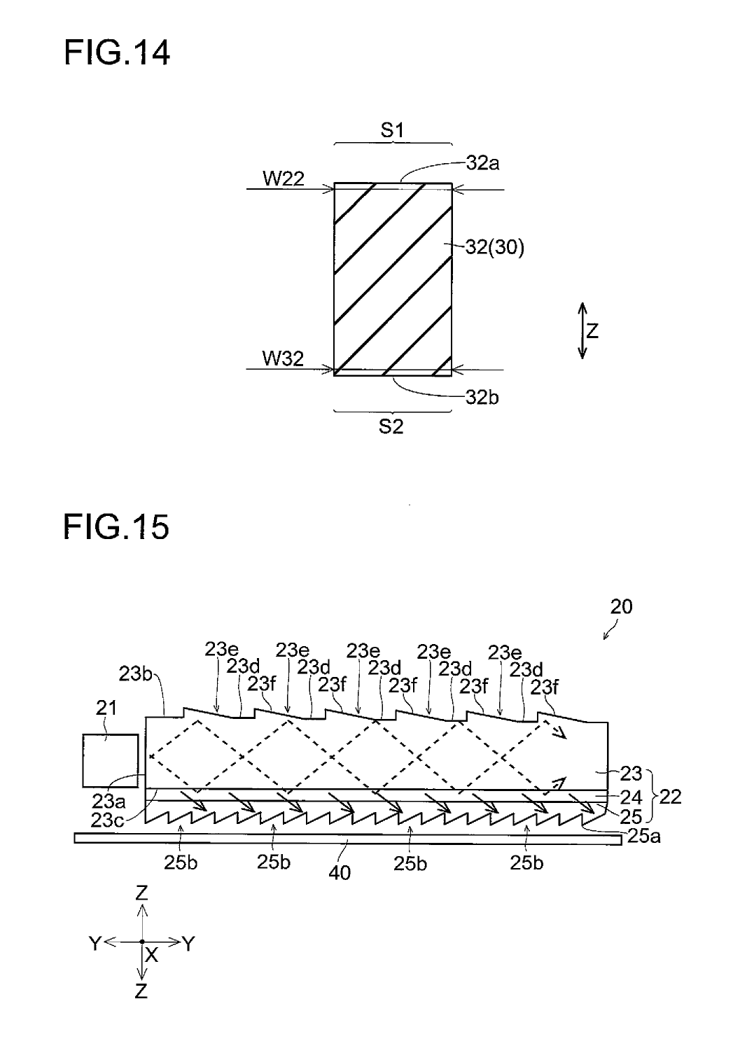

FIG. 11 is a drawing schematically illustrating a cross-section taken along the XI-XI line in FIG. 10. FIG. 12 is a drawing schematically illustrating a cross-section of the liquid crystal display device provided with the liquid crystal display panel 10 and the backlight unit 20, and is a drawing corresponding to the cross-section of FIG. 11. FIG. 13 is a partially enlarged view of FIG. 12. FIGS. 11, 12, and 13 omit descriptions of the prisms, the low-refractive-index layer 24, the prism layer 25, and the like. FIG. 14 is a cross-sectional view taken along line XIV-XIV in FIG. 1

As illustrated in FIGS. 3, 11, and 12, the reflective sheet 40 is affixed by an adhesive layer 50 to a lower surface 32b of the frame 30 (walls 32). The opening 31 of the frame 30 (see FIG. 3) is covered by the reflective sheet 40. For example, double-sided tape or the like is used for the adhesive layer 50.

In the first embodiment, no stepped part is formed on the walls 32 of the frame 30. As described above, there is no condensing lens or other optical sheet (for example, a prism sheet or the like) arranged in the backlight unit 20. Therefore, no stepped part for supporting and fixing optical sheets (an optical sheet group) is formed on the frame 30. For this reason, the backlight unit 20 does not include the region of the width W1 illustrated in FIG. 42.

Leakage of light in the lateral direction (see FIG. 42) is brought about by multiple reflections between optical sheets. In the first embodiment, no prism sheet or other optical sheet is arranged, and emission (leakage of light) in the lateral direction (see the dashed arrows in FIGS. 11 to 13) is suppressed. For this reason, the backlight unit 20 has no need for a region for preventing leakage of light. Accordingly, the backlight unit 20 does not include the region of the width W3 illustrated in FIG. 42.

As such, as shown in FIGS. 11 and 12, the walls 32 of the frame 30 are composed only of regions to which the liquid crystal display panel 10 (see FIG. 12) is fixed (regions corresponding to the region of the width W2 illustrated in FIG. 42). As illustrated in FIG. 13, the width W (frame width W) of the walls 32 of the frame 30 is equal to the width W2 (see FIGS. 13 and 42) of the region of the portion to which the liquid crystal display panel 10 is fixed. For this reason, as illustrated in FIG. 14, the width W32 of the lower side of the cross-section of the walls 32 of the frame 30 and the width W22 of the upper side thereof are equal (substantially equal). For example, as illustrated in FIGS. 11 to 13, the cross-section of the walls 32 of the frame 30 is quadrangular (substantially quadrangular).

As illustrated in FIGS. 12 and 13, the liquid crystal display panel 10 is fixed (installed) onto an upper surface 32a of the frame 30 (walls 32) with an adhesive layer 51 interposed therebetween. For example, double-sided tape or the like is used for the adhesive layer 51.

Thus, the reflective sheet 40 is fixed to the lower surface 32b of the frame 30, and the liquid crystal display panel 10 is fixed to the upper surface 32a of the frame 30. For this reason, preferably, a surface area S1 of the upper surface 32a and a surface area S2 of the lower surface 32b are equal (substantially equal) (see FIG. 14).

As illustrated in FIG. 13, the frame width W of the frame 30 is the width necessary in order to have ample bonding strength in fixing the liquid crystal display panel 10 and the reflective sheet 40 to the frame 30. The frame width W (W2) of the frame 30 is preferably, for example, about 0.5 mm to about 1.0 mm.

In the backlight unit 20 of the first embodiment, the height T1 of the frame 30 (height T1 of the walls 32) is equal (substantially equal) to the thickness T2 of the light guide plate 22 (see FIG. 13).

Next, the optical paths of the light emitted from the LEDs 21 of the backlight unit 20 of the first embodiment shall be described, with reference to FIGS. 5, 7, 8, 11 to 13, and 15.

The light emitted from the LEDs 21 has the highest intensity in the front direction (Y direction) of the LEDs 21, and has a spread of ±90° in the X direction and Z direction in relation to the front direction. The light emitted from the LEDs 21, as illustrated in FIG. 5, is refracted upon becoming incident on the light incidence surface 23a of the light guide 23 (light guide plate 22), where the spread in the X direction and the Z direction in relation to the front direction becomes ±θ1. Here, the angle θ1 is the critical angle between the light guide 23 and the air layer, where θ1=arcsin(1/n1).

Out of the light that is incident on the light incidence surface 23a, light Q1 that travels toward the light emission surface 23b travels at an angle of incidence equal to or greater than θ2 (=90°−θ1−α1) toward the inclined surfaces 23f of the prisms 23e, and the majority thereof is totally reflected to the rear surface 23c side at the prisms 23e (the interface between the light emission surface 23b of the light guide 23 and the air layer).

Light Q2 that is totally reflected at the prisms 23e travels at an angle of incidence equal to or greater than θ3 (=90°−θ1−α1×2) toward the rear surface 23c (low-refractive-index layer 24). Here, out of the light Q2 that travels toward the rear surface 23c, only light of an angle of incidence less than the critical angle between the light guide 23 and the low-refractive-index layer 24 is incident on the low-refractive-index layer 24. On the other hand, out of the light Q2 that travels toward the rear surface 23c, light of an angle of incidence equal to or greater than the critical angle between the light guide 23 and the low-refractive-index layer 24 is totally reflected to the light emission surface 23b side at the rear surface 23c (the interface between the light guide 23 and the low-refractive-index layer 24).

Light Q3 that is totally reflected at the rear surface 23c travels at an angle of incidence equal to or greater than θ4 (=90°−θ1−α1×3) toward the inclined surfaces 23f, and is totally reflected to the rear surface 23c side at the prisms 23e.

Light Q4 that is totally reflected at the prisms 23e travels at an angle of incidence equal to or greater than θ5 (=90°−θ1−α1×4) toward the rear surface 23c (low-refractive-index layer 24). Here, out of the light Q4 that travels toward the rear surface 23c, only light of an angle of incidence less than the critical angle between the light guide 23 and the low-refractive-index layer 24 is incident on the low-refractive-index layer 24. On the other hand, out of the light Q4 that travels toward the rear surface 23c, light of an angle of incidence equal to or greater than the critical angle between the light guide 23 and the low-refractive-index layer 24 is totally reflected to the light emission surface 23b side at the rear surface 23c.

Thus, the repeated reflection of the light emitted from the LEDs 21 between the prisms 23e (light emission surface 23b) and the rear surface 23c causes the light to be guided and incident onto the low-refractive-index layer 24 so that the angle of incidence with respect to the rear surface 23c gradually decreases.

The light that is emitted from the LEDs 21 is repeatedly reflected between the prisms 23e and the rear surface 23c, thereby causing the angle of incidence with respect to the rear surface 23c to be reduced by about α1×2 at a time. For this reason, the spread angle, in the Y direction, of the light incident on the low-refractive-index layer 24 is about α1×2 or less.

Out of the light that is incident on the light incidence surface 23a, light Q5 that travels toward the rear surface 23c is likewise incident on the low-refractive-index layer 24 by being repeatedly reflected between the rear surface 23c and the prisms 23e (light emission surface 23b).

That is to say, as illustrated in FIG. 15, the propagation angle of light that is incident inside the light guide 23 from the light incidence surface 23a is changed at the prisms 23e and at the prisms 23i (see FIG. 7). That light then carries on gradually being incident onto the low-refractive-index layer 24 (see the rectilinear arrow). Adjusting the shapes and densities of the prisms 23e and the prisms 23i makes it possible to cause the light that is incident on the low-refractive-index layer 24 to be uniform over the entire surface.

Thereafter, as illustrated in FIG. 8, light that is incident on the low-refractive-index layer 24 is forthwith incident on the prism layer 25 and, after being repeatedly refracted and transmitted at the prisms 25b provided to the prism layer 25, is emitted forward from the light emission surface 23b of the light guide plate 22 (light guide 23). To describe in detail, all (substantially all) of the light incident on the low-refractive-index layer 24 is totally reflected (see the dashed arrows) forward (to the liquid crystal display panel 10 side) at the inclined surfaces 25c of the prisms 25b (at the interface between the inclined surfaces 25c of the prisms 25b and the air layer), or, is transmitted and thereafter totally reflected (see the dashed arrows). Then, the totally reflected light (see the dashed arrows) is again incident on the light guide 23 and emitted forward (to the liquid crystal display panel 10 side) from the light emission surface 23b (see FIG. 5).

The refractive index n1 of the light guide 23 is 1.42 or greater (for example, about 1.59 to about 1.65), and the refractive index of the air layer is about 1. Accordingly, the critical angle between the light guide 23 and the air layer is smaller than the critical angle between the light guide 23 and the low-refractive-index layer 24. For this reason, there exists substantially no light that is emitted from the light emission surface 23b without having passed through the prisms 25b.

Thus, in the first embodiment, uniformity and condensing of light are realized with the light guide plate 22 alone. For this reason, as illustrated in FIGS. 11 to 13, the light is uniformly emitted from the light guide plate 22 (see the solid arrow). Also, with such a configuration of sheetless backlight (light guide plate), the light is essentially propagated only inside the light guide plate 22, and once emitted from the light emission surface of the light guide plate 22, the light does not return again to the light guide plate 22 nor to the reflective sheet 40, and thus the emission of light in the lateral direction (see the dashed arrows) is effectively suppressed.

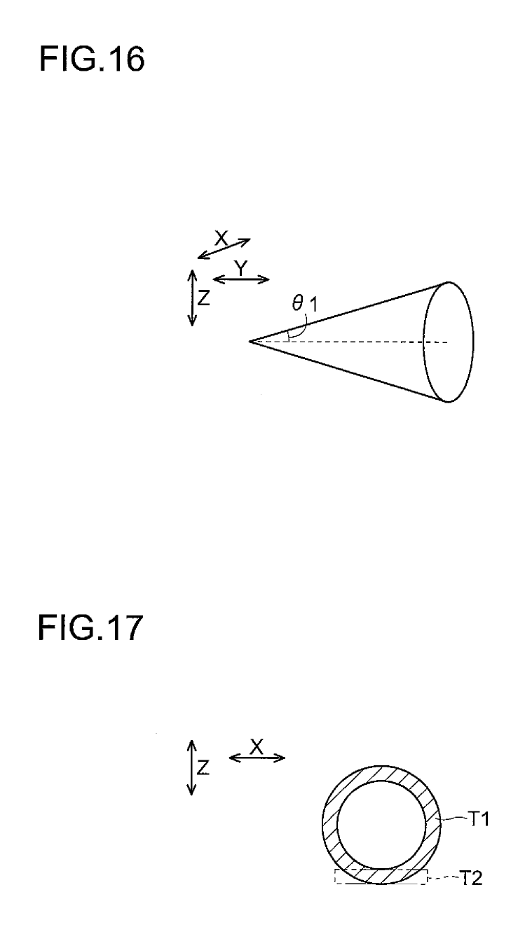

Next, the reason for which spreading of the light emitted from the light guide plate 22 in the X direction is suppressed shall be described in greater detail, with reference to FIGS. 16 to 21.

The light emitted from the LEDs 21 has a spread of ±90° in the X direction and Z direction in relation to the front direction (Y direction) of the LEDs 21. The light emitted from the LEDs 21 is refracted upon becoming incident on the light incidence surface 23a, where, as illustrated in FIG. 16, the spread in the X direction and the Z direction in relation to the Y direction becomes ±θ1. The angle θ1 is the critical angle between the light guide 23 and the air layer.

Here, the following formula (1) holds true when, inside the light guide 23, the light is present in ranges of the angle θ in the X direction and the Z direction in relation to the Y direction.

θ≦θ1=arcsin (1/n1) (1)

Only light of a region satisfying the following formula (2), where φ is the critical angle between the light guide 23 and the low-refractive-index layer 24, is able to be incident on the low-refractive-index layer 24.

π/2−θ<φ=arcsin(n2/n1) (2)

A depiction of this region is the region T1 (the shaded region) in FIG. 17. As shall be described below, however, the light in the region T2 in FIG. 17 is the only portion of light that can actually be incident on the low-refractive-index layer 24 out of the light immediately after having been incident on the light guide 23. The reason for this shall be described below.

The angle of incidence of the light on the low-refractive-index layer 24 is π/2−θ_{C}, where θ_{C} is the component of spread in the Z direction of the light that is incident on the light guide 23. The condition for light to be incident on the low-refractive-index layer 24 is π/2−θ_{C}<φ, and because 0<π/2−θ_{C}<90, the following formula (3) is obtained.

cos(π/2−θ_{C})=sin θ_{C}>cos φ (3)

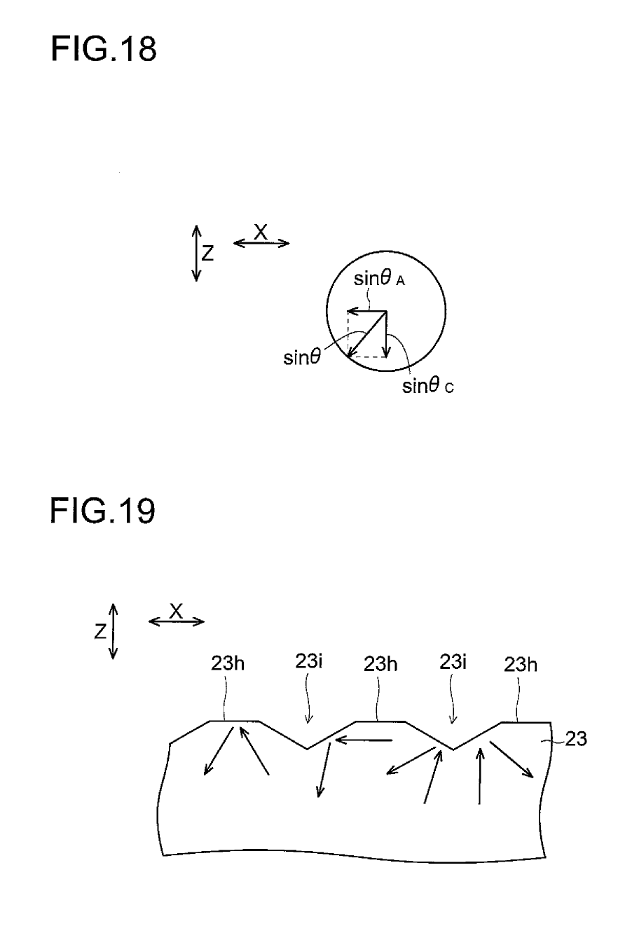

From FIG. 18, θ_{A} satisfies the following formula (4), where θ_{A} is the component of spread in the X direction of the light that is incident on the light guide 23.

sin² θ_{A}=sin² θ−sin² θ_{C} (4)

Here, because sin θ≦sin θ1 and cos φ<sin θ_{C}≦sin θ1 in the light of formulae (1) and (3), the following formula (5) is obtained using the formula (4).

0≦sin² θ_{A}<sin² θ−cos² φ (5)

When, for example, n1=1.59 and n2=1.35, the range available for θ_{A} is 0≦θ_{A}<19.95, and the spread of light in the X direction can be suppressed. The effect of suppressing the spread of light in the X direction slightly weakened by the prisms 23i, but because the width W13 of the flat parts 23h in the X direction is the size equal to or less than the width W14 of the prisms 23i in the X direction, increasing the angle of incline (reducing the apex angle) of the prisms 23i makes it possible to maintain the majority of the effect of suppressing the spread of light in the X direction.

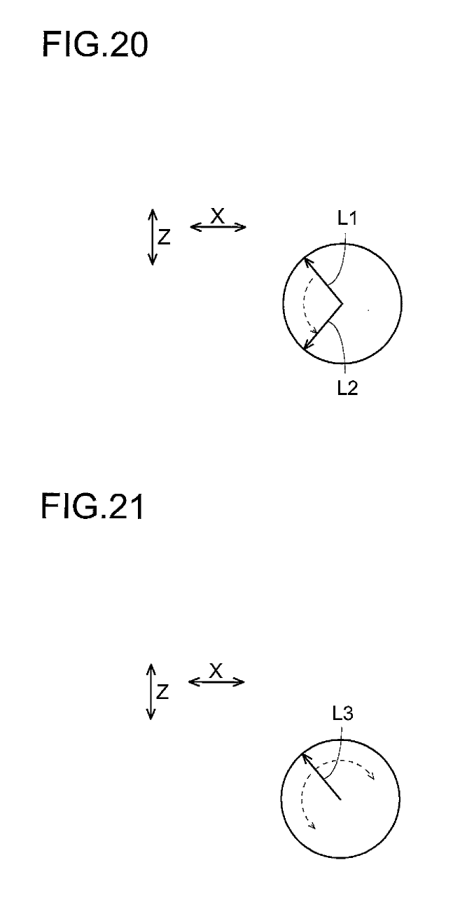

The impact of the flat parts 23h and the prisms 23i shall now be further described. In FIG. 20, L1 illustrates the light before being reflected at the flat parts 23h, and L2 illustrates the light after having been reflected at the flat parts 23h. In FIG. 21, L3 illustrates the light before being reflected at the prisms 23i. As illustrated in FIGS. 19 and 20, the orientation in the Z direction is inverted while the spread in the Y direction and X direction is maintained. The light reflected at the prisms 23i of the light guide 23, however, experiences a change in the component of spread in the Z direction and X direction while the spread in the Y direction is maintained, as illustrated in FIGS. 19 and 21.

For this reason, a disproportionate spread of light in the Z direction and X direction inside the light guide 23 can be suppressed. That is to say, the prisms 23i cause the spread of light in the Z direction and X direction to change inside the light guide 23 at all times, enabling the Z direction and X direction components to be rendered equivalent.

This causes the light of the region T1 (see FIG. 17) that satisfies the formula (2) to be incident on the low-refractive-index layer 24 when the formula (3) is satisfied, due to an alteration of the component of spread in the Z direction and the X direction caused by the prisms 23i. As a result, light for which spreading in the X direction has been suppressed can be emitted uniformly from the light guide plate 22.

In the first embodiment, as described above, the plurality of prisms 23e are provided to the light emission surface 23b. The light coming from the LEDs 21 is guided while being repeatedly reflected between the light emission surface 23b and the rear surface 23c. The angle of incidence of the light with respect to the rear surface 23c gradually decreases. Then, the light coming from the LEDs 21 is incident on the low-refractive-index layer 24 in a case where the angle of incidence of light with respect to the rear surface 23c is less than the critical angle between the light guide 23 and the low-refractive-index layer 24.

For this reason, the angle of spread in the Y direction of the light incident on the low-refractive-index layer 24 is reduced, and the angle of spread in the Y direction of light that is reflected at the interface between the rear surface 25a of the prism layer 25 and the air layer is also reduced. That is to say, the light condensing properties can be improved and the brightness of the liquid crystal display panel 10 can be improved. As a result, there is no need to arrange a plurality of optical sheets (condensing lenses or the like) on the light guide plate 22, making it possible to reduce the thickness of the backlight unit 20 and possible to suppress an increasing in the cost of production.

Because there is no need to provide a plurality of optical sheets, no light is lost in passing through any optical sheets (for example, there is no light loss caused by multiple reflections between sheets). The efficiency of utilization of light is accordingly improved.

Moving increasingly away from the LEDs 21, the angle of incidence with respect to the rear surface 23c of the light guide 23 is reduced and the light coming from the LEDs 21 is more readily incident on the low-refractive-index layer 24. This makes it possible for there to be a uniform amount of light incident on the low-refractive-index layer 24 at a portion close to the LEDs 21, where there is a large amount of light (light flux), and a portion far away from the LEDs 21, where there is less light (light flux). As a result, light can be uniformly emitted from the entire light emission region 22a of the light guide plate 22, and the brightness of the liquid crystal display panel 10 can be rendered uniform.

The plurality of prisms 25b, which reflect forward the light coming from the LEDs 21, are fowled on substantially the entire rear surface 25a (at least on a portion corresponding to the entire light emission region 22a) of the prism layer 25, in the light emission region 22a of the light guide plate 22. Therefore, the plurality of prisms 25b make it possible to uniformly reflect the light in the entire (substantially the entire) light emission region 22a. This makes it possible to more uniformly emit the light from the entire light emission region 22a of the light guide plate 22, and therefore makes it possible to suppress the occurrence of dot unevenness and also possible to render the brightness of the liquid crystal display panel 10 more uniform.

The plurality of the prisms 25b have the function of totally reflecting the light coming from the LEDs 21. Emission, from the rear surface 25a of the prism layer 25, of light that is incident on the low-refractive-index layer 24 (prism layer 25) from the light guide 23 can be suppressed. The occurrence of loss of light can be suppressed, and the efficiency of utilization of light can be further improved.

The utilization of this light guide plate 22 makes it possible to improve the illumination quality of the backlight unit 20 without having to provide prism sheets or other optical sheets (an optical sheet group). Therefore, no stepped part for supporting and fixing the optical sheets (optical sheet group) need be provided to the frame 30. The width W of the walls 32 of the frame 30 can be reduced by a commensurate amount. Leakage of light in the lateral direction can also be suppressed, and thus there is no need to provide a region for blocking light (a region corresponding to the width W3 in FIG. 42) to the walls 32 of the frame 30. Accordingly, the width W (frame width W) of the walls 32 of the frame 30 can be rendered equal (substantially equal) to the width W2 of the region of the portion to which the liquid crystal display panel 10 is fixed (see FIGS. 13 and 42). In addition, the width W of the walls 32 of the frame 30 can be rendered equal (substantially equal) between the lower side and upper side. As a result, because the width W of the walls 32 of the frame 30 can be reduced, a narrower frame width can be achieved and the non-display region (ineffective region) can be reduced.

With the liquid crystal display device 1 comprising the backlight unit 20 of such description, it is possible to reduce the scale of equipment while also increasing the display region. In addition, the design performance and freedom of design can be improved. Furthermore, with the backlight unit 20, the optical sheets (optical sheet group) is obviated, and the steps for assembling (assembly of) the backlight can be simplified.

When the frame 30 is constituted of a light-blocking resin material, the leakage of light in the lateral direction can be effectively suppressed, and the frame width can be more readily narrowed. Here, in a case where the frame is constituted of a light-blocking resin, the brightness near the frame is reduced on the display surface (light-emitting surface) in a conventional configuration. For this reason, the uniformity of the backlighting light is reduced. In the first embodiment, however, a sheetless backlight is used, and a decrease in brightness near the frame 30 can be effectively reduced. For this reason, having the frame 30 be constituted of a light-blocking resin makes it possible to more effectively suppress the leakage of light in the lateral direction.

The light emission surface 23b and the rear surface 23c are parallel (substantially parallel) with one another. The low-refractive-index layer 24 is easier to form on the rear surface 23c of the light guide 23 in comparison to a case where a wedge-shaped light guide of which the rear surface is inclined with respect to the light emission surface were to be used.

The prisms 23e comprise the inclined surfaces 23f that are inclined with respect to the light emission surface 23b. The angle of incidence of the light coming from the LEDs 21 with respect to the rear surface 23c of the light guide 23 can be easily made to gradually decrease.

In case where the angle of incline of the inclined surfaces 23f with respect to the light emission surface 23b is set to 5° or less (0.1° to 3°), the light is repeatedly reflected between the prisms 23e and the rear surface 23c, and the angle of incidence of the light with respect to the rear surface 23c is reduced in increments of 10° or less (0.2° to 6°). Accordingly, it is even easier to cause the angle of incidence of the light with respect to the rear surface 23c to gradually decrease.

The flat parts 23d are formed between prisms 23e that are adjacent to each other in the Y direction. Accordingly, dispersing of light emitted from the light guide 23 can be suppressed.

The plurality of prisms 25b are formed continuously, without any gap in the Y direction. The plurality of prisms 25b make it possible for the light to be more uniformly reflected. Accordingly, the light can be more uniformly emitted from the entire light emission region 22a of the light guide plate 22. This makes it possible to cause the brightness of the liquid crystal display panel 10 to be more uniform.

Forming the plurality of prisms 25b with the same shape and same size enables the plurality of prisms 25b to more uniformly reflect the light, and thus makes it possible to cause the light to be more uniformly emitted from the entire light emission region 22a of the light guide plate 22.

The plurality of prisms 23i for diffusing the light coming from the LEDs 21 in the X direction are formed on the light emission surface 23b (the light emission region 22a). The light can be properly diffused in the X direction inside the light guide 23. The brightness of the front portion of the LEDs 21 in the liquid crystal display panel 10 and the brightness of portions other than the front portion of the LEDs 21 in the liquid crystal display panel 10 can both be rendered uniform. That is to say, the brightness of the liquid crystal display panel 10 can be rendered more uniform. The prisms 23i make it possible to suppress the occurrence of linear unevenness and make it possible to effectively suppress uneven brightness.

The light having a large angle of incidence with respect to the rear surface 23c as seen from the light incidence surface 23a side is reflected by the prisms 23i. Accordingly, the angle of incidence with respect to the rear surface 23c can be reduced. This makes it possible to suppress spreading, in the X direction, of the light that is incident on the low-refractive-index layer 24, and makes it possible to suppress spreading, in the X direction, of light that is emitted from the light guide plate 22. As a result, it is possible to improve the light-condensing properties for the light in the X direction, and also to further improve the brightness of the liquid crystal display panel 10.

The prisms 23i are formed of the pairs of inclined surfaces 23j. The light coming from the LEDs 21 is diffused to both sides in the X direction by the pairs of inclined surfaces 23j. Accordingly, the brightness of the liquid crystal display panel 10 can be rendered more uniform.

The case where the LEDs 21 are used as light sources is susceptible to a difference between the brightness of the front portion of the LEDs 21 in the liquid crystal display panel 10 and the brightness of portions other than the front portion of the LEDs 21 in the liquid crystal display panel 10. It is particularly effective to provide the plurality of prisms 23i, which diffuse the light coming from the LEDs 21 in the X direction.

Being provided with the backlight unit 20 of such description makes it easy to obtain the small, thin liquid crystal display device 1 having excellent display quality and a successfully narrowed frame width.

### Second Embodiment

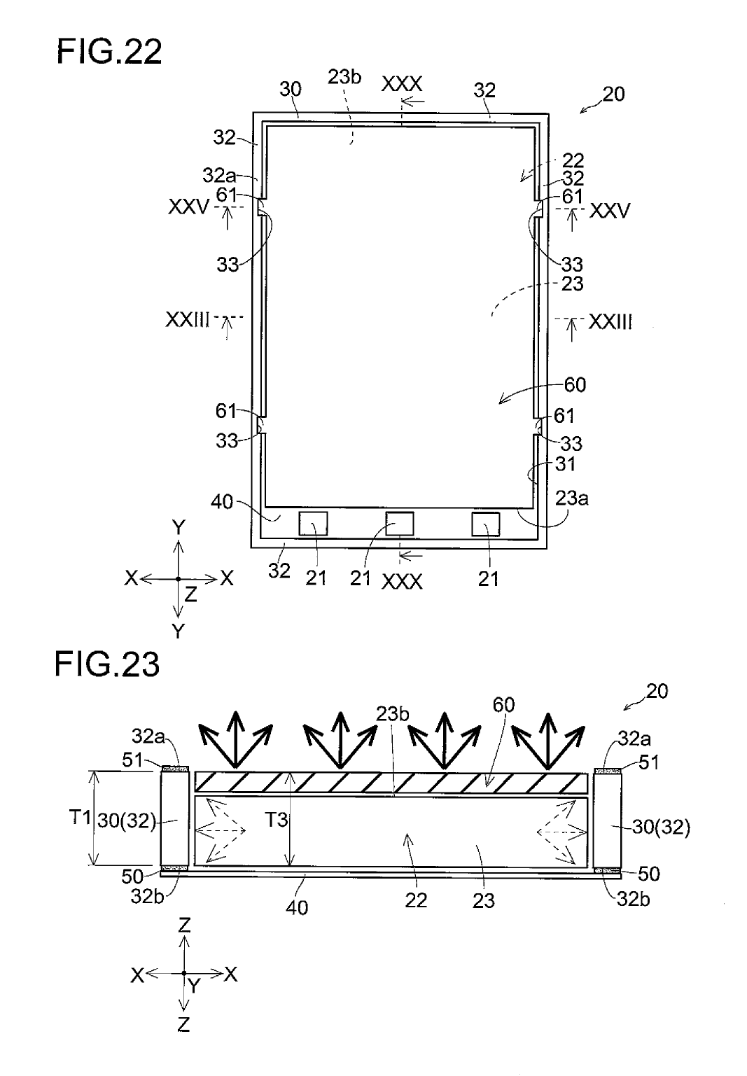

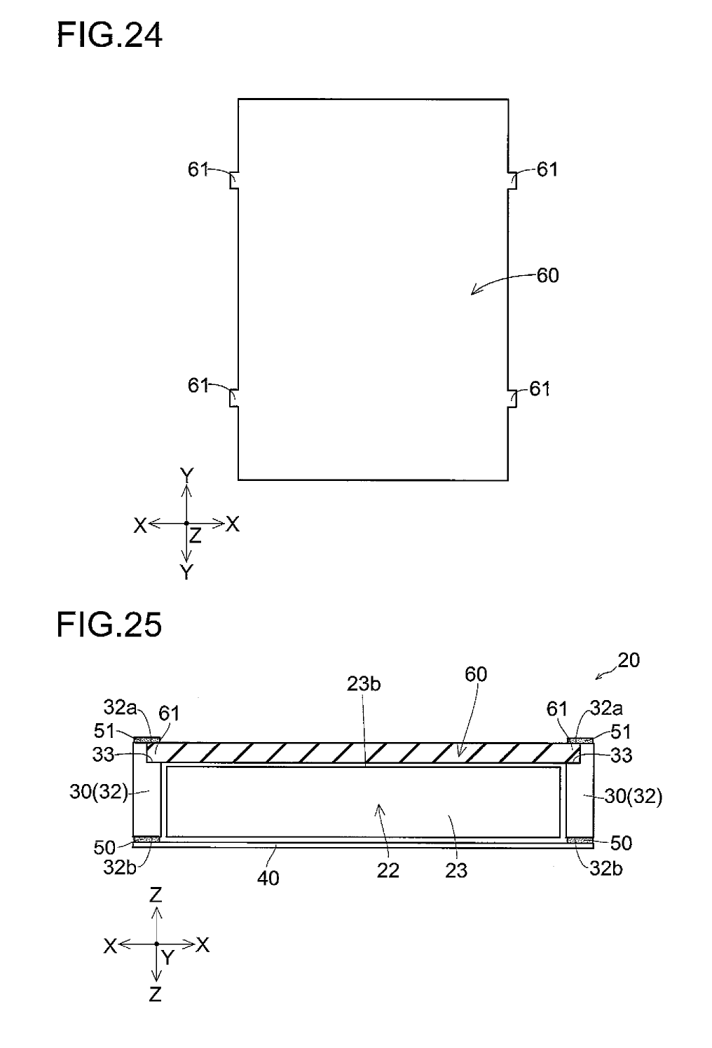

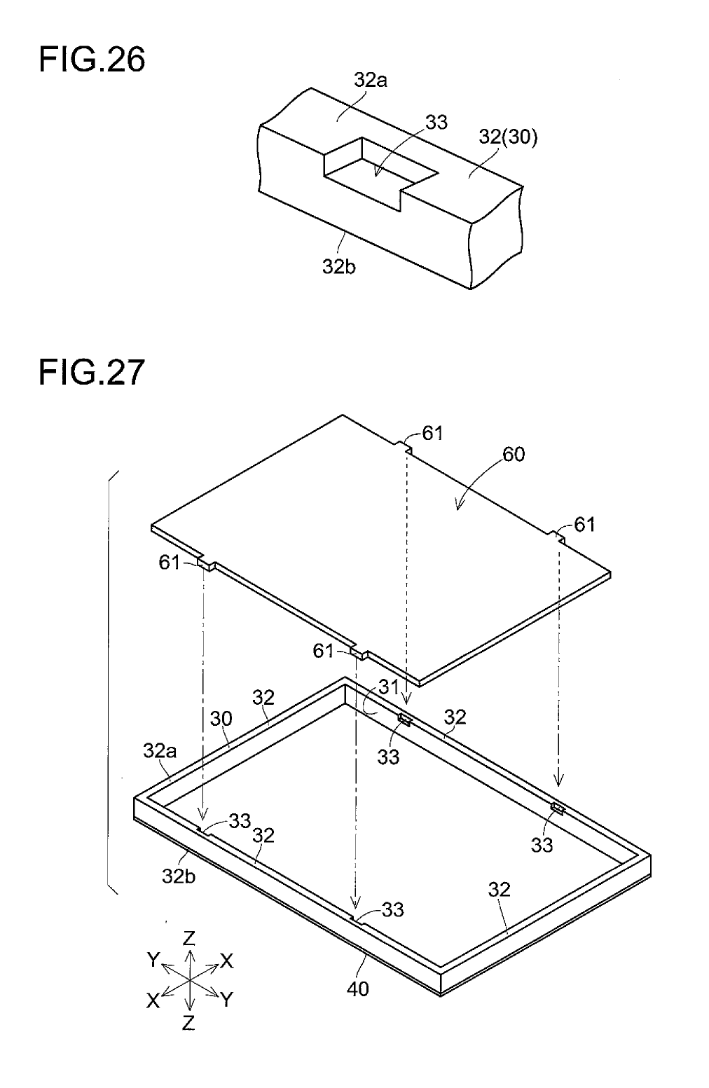

The backlight unit of the second embodiment of the present invention shall now be described, with reference to FIGS. 12 and 22 to 30. FIG. 22 is a plan view illustrating a light unit of the second embodiment. FIG. 23 is a drawing schematically illustrating a cross-section taken along line XXIII-XXIII in FIG. 22. FIG. 24 is a plan view of a diffusion sheet of the second embodiment. FIGS. 25 to 30 are drawings for describing the backlight unit of the second embodiment. In each of the drawings, corresponding constituent elements are assigned like reference numerals, allowing for the omission, as appropriate, of redundant descriptions.

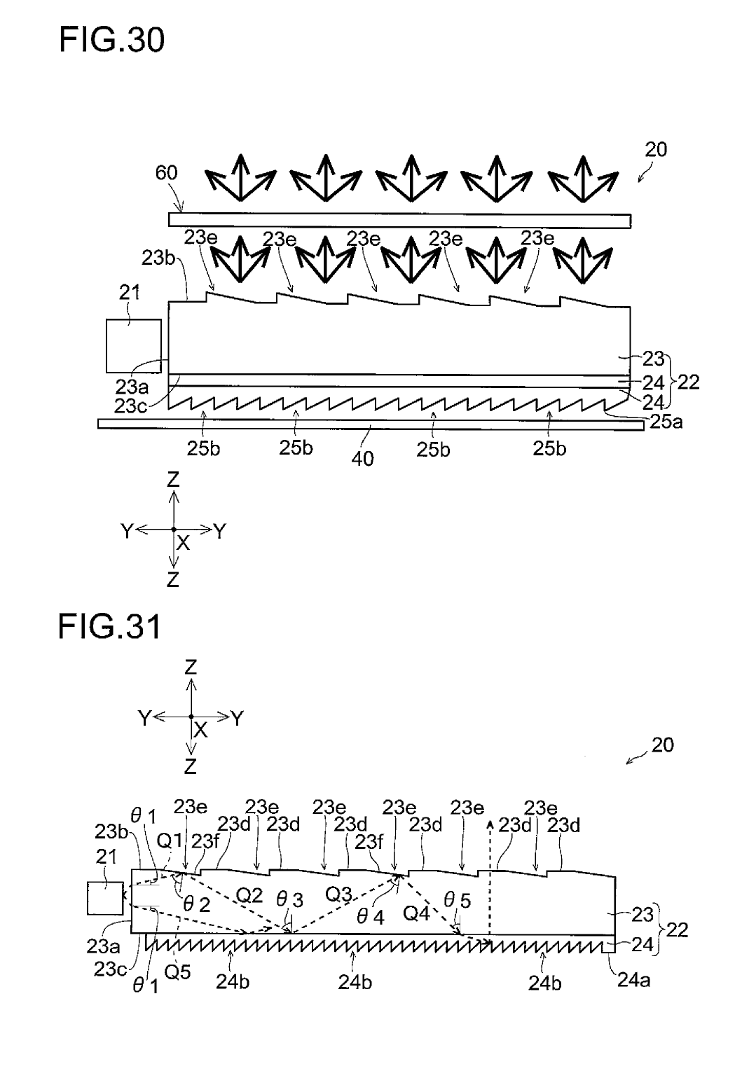

FIG. 25 is a drawing schematically illustrating a cross-section taken along line XXV-XXV in FIG. 22. FIGS. 23 and 25 omit the details of the light emission surface 23b and omit mention of the low-refractive-index layer 24, the prism layer 25, and the like. FIG. 30 is a drawing schematically illustrating a cross-section of a liquid crystal display device provided with the backlight unit 20, and is a drawing corresponding to a cross-section taken along line XXX-XXX in FIG. 22.

In the second embodiment, the backlight unit 20 is further provided with a diffusion sheet (diffusion plate) 60, as illustrated in FIGS. 22 and 23. The size of the diffusion sheet 60 is equal (substantially equal) to the size of the light guide plate 22. The diffusion sheet 60 is laid on the light guide plate 22 and arranged inside the frame 30. The diffusion sheet 60 is arranged on the upper surface of the light guide plate 22. In the second embodiment, the height T1 of the walls (frame parts) 32 of the frame 30 is equal (substantially equal) to the combined thickness T3 of the thickness of the light guide plate 22 and the thickness of the diffusion sheet 60 (see FIG. 23).

As illustrated in FIG. 24, the diffusion sheet 60 has protrusions 61 that protrude outwardly, as seen in plan view. On the other hand, as illustrated in FIGS. 25 to 27, notches 33 are formed in the walls 32 of the frame 30. The protrusions 61 of the diffusion sheet 60 are fitted to the notches 33 of the frame 30, and the diffusion sheet 60 is supported by the frame 30.

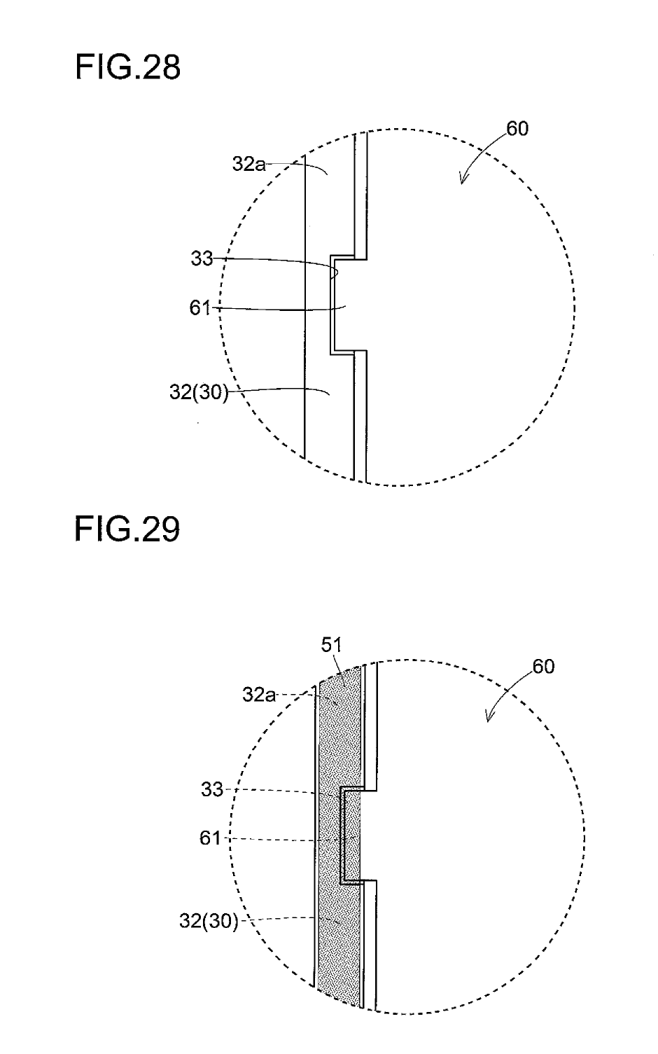

The notch depth of the notches 33 of the frame 30 is the same (substantially the same) as the thickness of the diffusion sheet 60. As illustrated in FIGS. 25 and 28, in the state where the diffusion sheet 60 is supported by the frame 30, the upper surface 32a of the frame 30 (walls 32) and the upper surface of the diffusion sheet 60 are on the same plane (substantially the same plane).

The adhesive layer 51 for fixing the liquid crystal display panel 10 (see FIG. 12) is provided to the upper surface 32a of the frame 30 (see FIGS. 23 and 25). The diffusion sheet 60 is fixed to the frame 30 by the adhesive layer 51. Described in greater detail, for example, a double-sided tape is affixed to the upper surface 32a of the frame 30, as the adhesive layer 51. The double-sided tape (adhesive layer 51) is affixed so as to overlap with the protrusions 61 of the diffusion sheet 60, as illustrated in FIGS. 25 and 29. The double-sided tape (shaded portion in FIG. 29) causes the diffusion sheet 60 to be pressed down and causes the diffusion sheet 60 to be fixed to the frame 30.

In the backlight unit 20 of the second embodiment, as illustrated in FIG. 30, light that is emitted from the light emission surface 23b of the light guide plate 22 (light guide 23) is scattered in passing through the diffusion sheet 60. Unevenness of brightness is not readily perceived. Accordingly, the illumination quality can be further improved.

With the diffusion sheet 60, warping or displacement of the sheet or the like causes less of an impact on the properties than would another optical sheet such as a prism sheet. Accordingly, even in the case where the backlight unit 20 comprises the diffusion sheet 60, it is possible to facilitate the steps for assembling (assembly).

The diffusion sheet 60 has the outwardly protruding protrusions 61 and the walls 32 of the frame 32 have the notches 33 into which the protrusions 61 are fitted. Accordingly, the frame 30 can be supported by the diffusion sheet 60 without increasing the width of the walls 32 of the frame 30. It is easy to narrow the frame width even in the case where the backlight unit 20 comprises the diffusion sheet 60.

Other configurations and effects of the second embodiment are similar to those of the first embodiment.

### Third Embodiment

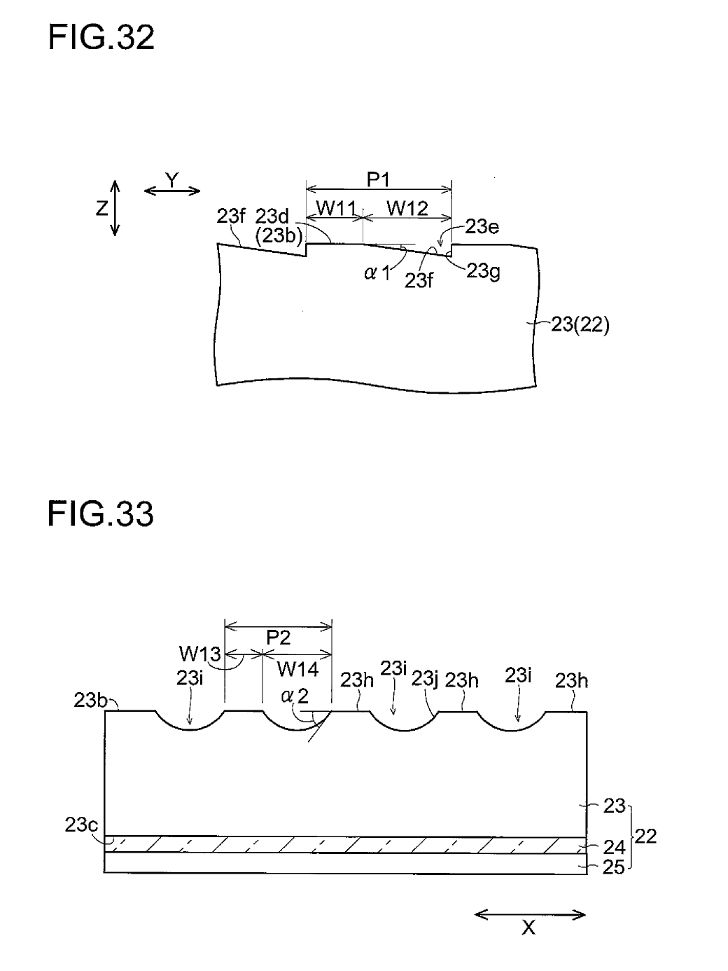

The backlight unit of the third embodiment of the present invention shall now be described, with reference to FIGS. 5, 31, and 32. FIG. 31 is a cross-sectional view schematically illustrating the backlight unit of the third embodiment. FIG. 32 is an enlarged cross-sectional view illustrating the structure of the light emission surface of the light guide of the backlight unit of the third embodiment. In each of the drawings, corresponding constituent elements are assigned like reference numerals, allowing for the omission, as appropriate, of redundant descriptions.

In the third embodiment, the light guide plate 22 is constituted of the light guide 23 and the low-refractive-index layer 24, as illustrated in FIG. 31. That is to say, in the third embodiment, the light guide plate 22 does not have the prism layer 25 (see FIG. 5). Further, in the third embodiment, prisms 24b similar to the prisms 25b formed on the prism layer 25 (see FIG. 5) are formed on the rear surface 24a of the low-refractive-index layer 24 of the light guide plate 22. That is to say, the configuration of the third embodiment is similar to a case where the refractive index n2 of the low-refractive-index layer 24 and the refractive index n3 of the prism layer 25 are equal (n2=n3) in the first embodiment.

Further, in the third embodiment, the prisms 23e of the light guide 23 are concave prisms, as illustrated in FIGS. 31 and 32.

In the third embodiment, too, similarly with respect to the first embodiment, the illumination quality of the backlight unit 20 can be improved without providing prism sheets or other optical sheets (an optical sheet group). For this reason, similarly with respect to the first embodiment, the leakage of light in the lateral direction can be effectively suppressed. As such, in a case configured in this manner, it is still easy to narrow the frame width, reduce size, and reduce thickness, and possible to facilitate the steps for assembling (assembly of) the backlight.

Other configurations and effects of the third embodiment are similar to those of the first and second embodiments.

The embodiments disclosed herein are in all respects provided by way of example and should not be construed as being restrictive. The scope of the present invention is indicated by the claims, not by the descriptions of the embodiments above, and further includes all modifications made within a meaning and scope equivalent to the claims.

In the first through third embodiments, the liquid crystal display device 1 is an example of the “display device” of the present invention, and the liquid crystal display panel 10 is one example of the “display panel” of the present invention. The backlight unit 20 is one example of the “illumination device” of the present invention.

For example, the illumination device of the present invention may be applied to an illumination device other than a backlight unit. For example, the illumination device of the present invention may be applied to general illumination such as indoor illumination or outdoor lighting.

The display panel and display device of the present invention may be a display panel and display device other than a liquid crystal display panel and liquid crystal display device.

In the first through third embodiments, the display device is a liquid crystal display device used as a display unit of a portable machine such as a portable terminal. However, the display device may be a display device used as a display unit of a machine other than a portable machine.

In the first through third embodiments, a frame-shaped frame having no bottom is used. However, the accommodation member for accommodating the light guide plate, light source, and the like may also be a configuration (frame configuration) that has a bottom. For example, the accommodation member for accommodating the light guide plate, the light source, and the like may be a box-shaped (substantially box-shaped) member. In such a case, the reflective sheet is arranged on the bottom of the accommodation member.

In each of the embodiments, the reflective member need not be arranged on the rear surface side of the light guide plate.

In the first through third embodiments, double-sided tape is used as one example of the adhesive layer. However, the adhesive layer need not be double-sided tape. For example, the adhesive layer may be an adhesive or the like.

In the first through third embodiments, the cross-section of the prisms (prisms 23i) for diffusing the light in the lateral direction has a triangular shape. However, the prisms 23i do not need to have a triangularly-shaped cross-section. The shape of the prisms 23i is not particularly limited, provided that the prisms 23i have inclined surfaces with which light can be reflected and the angle of light-guiding can be changed. For example, the cross-section of the prisms 23i may be arcuate, as illustrated in FIG. 33. The cross-section of the prisms 23i may also be another shape.

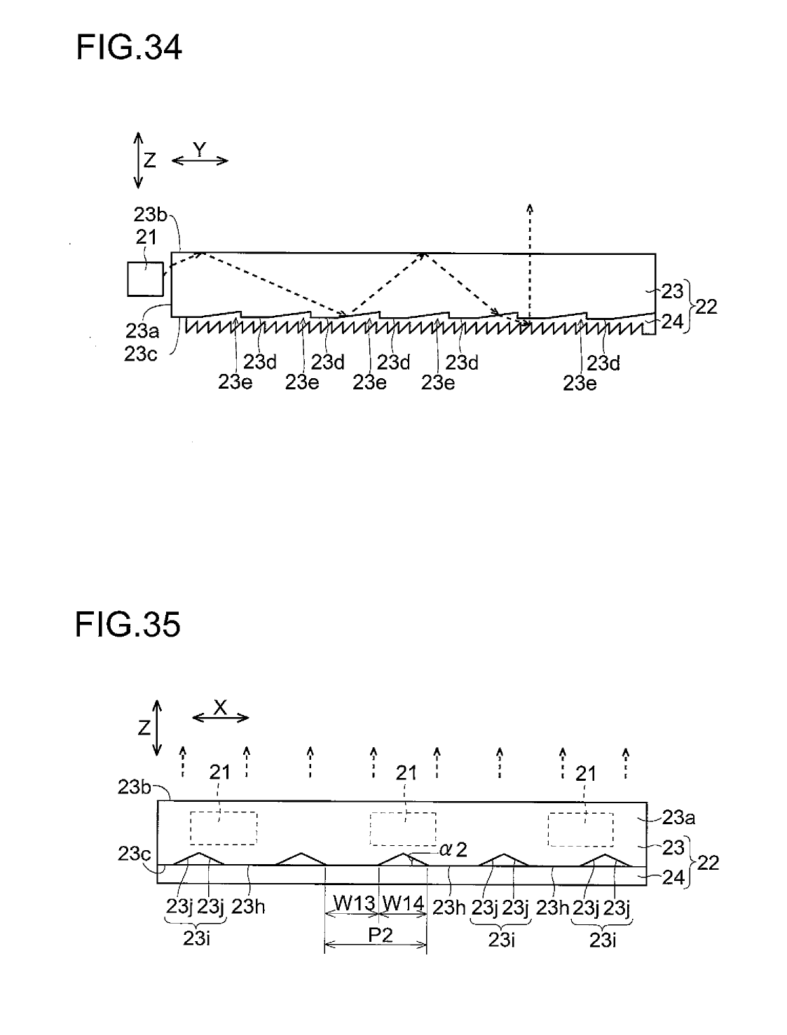

In the first through third embodiments, the light emission surface (front surface) of the light guide has formed thereon prisms (the prisms 23e) for gradually reducing the angle of incidence of the light coming from the LEDs with respect to the rear surface of the light guide, and prisms (the prisms 23i) for diffusing the light in the lateral direction. However, these prisms may be formed elsewhere other than the light emission surface (front surface) of the light guide. For example, as illustrated in FIG. 34, the prisms 23e for gradually reducing the angle of incidence of the light coming from the LEDs 21 with respect to the rear surface 23c of the light guide 23 may be formed on the rear surface 23c of the light guide 23. Also, as illustrated in FIG. 35, the prisms 23i for diffusing the light in the lateral direction may be formed on the rear surface 23c of the light guide 23. Here, either both the prisms 23e and the prisms 23i may be formed on the rear surface 23c of the light guide 23, or one of either the prisms 23e or the prisms 23i may be formed on the rear surface 23c of the light guide 23.

In each of the embodiments, each of the prisms (prisms 23e, prisms 23i) formed on the light guide may be formed on one side of the light guide (either the front surface or the rear surface) or may be formed on both sides of the light guide (the front surface and the rear surface).

In each of the embodiments, a material of a different refractive index may be interposed between the light guide (refractive index n1) and the low-refractive-index layer (refractive index n2). In such a case, the relationship between the refractive index (n1) of the light guide, the refractive index (n2) of the low-refractive-index layer, and the refractive index (n5) of the interposed layer is preferably n2<n5≦n1.

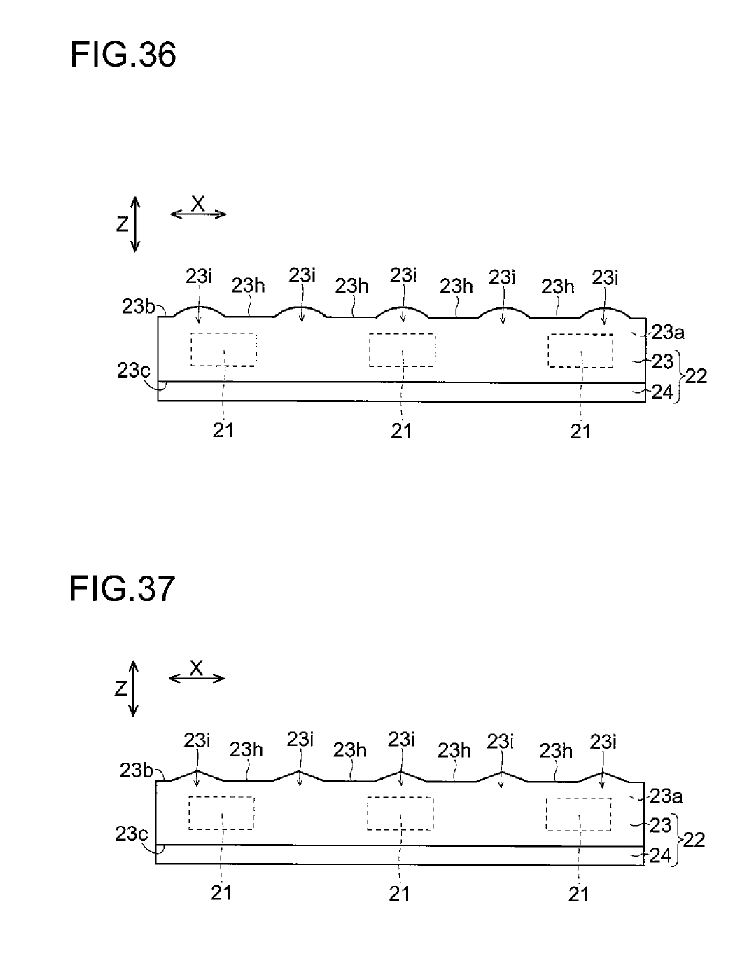

In each of the embodiments, the prisms (prisms 23i) for diffusing the light in the lateral direction are formed so as to be concave. However, these prisms may be formed to a shape other than concave. For example, as illustrated in FIGS. 36 and 37, the shape of the prisms 23i may be an upwardly protruding convexity. In such a case, the cross-section of the convex prisms 23i may be arcuate (see FIG. 36), may be triangular (see FIG. 37), or may alternatively be another shape such as elliptical. Similarly, the prisms (prisms 23e) may be of another shape, such as convex.

In each of the embodiments, the prisms (prisms 23i) for diffusing the light in the lateral direction are formed so as to extend in the direction perpendicular (substantially perpendicular) to the light incidence surface. However, the shape of the prisms may be another shape that has a similar function to the above description.

In each of the embodiments, LEDs are used as the light source. However, light-emitting elements other than LEDs may be used as the light source, or a light source other than light-emitting elements (for example, a cold-cathode fluorescent lamp (CCFL) or the like) may be used as the light source. The light source should be arranged on at least one side of the backlight unit (light guide). The number of light sources (for example, LEDs) should be one or more.

In each of the embodiments, the values for the angles, widths, and the like are illustrative examples, and may be other values. The number of LEDs and the like may also be modified as appropriate.

In the first embodiment, the height of the frame and the thickness of the light guide plate are equal (substantially equal). However, the height of the frame and the thickness of the light guide plate may be different. For example, the height of the frame may be greater than the thickness of the light guide plate. In such a case, the distance between the light guide plate and the liquid crystal display panel is ensured.

In the second embodiment, the size of the diffusion sheet is equal (substantially equal) to the size of the light guide plate. However, the size of the diffusion sheet may be different from the size of the light guide plate. However, it is preferable for the size of the diffusion sheet to be equal (substantially equal) to the size of the light guide plate.

In the second embodiment, the diffusion sheet has the protrusions, and the frame has the notches. However, the diffusion sheet need not have the protrusions. With the configuration illustrated in the second embodiment, however, the diffusion sheet can be fixed to the frame without increasing the frame width of the frame. The configuration illustrated in the second embodiment is therefore preferable. In the second embodiment, the number, shape, and the like of the protrusions of the diffusion sheet may be modified as appropriate.

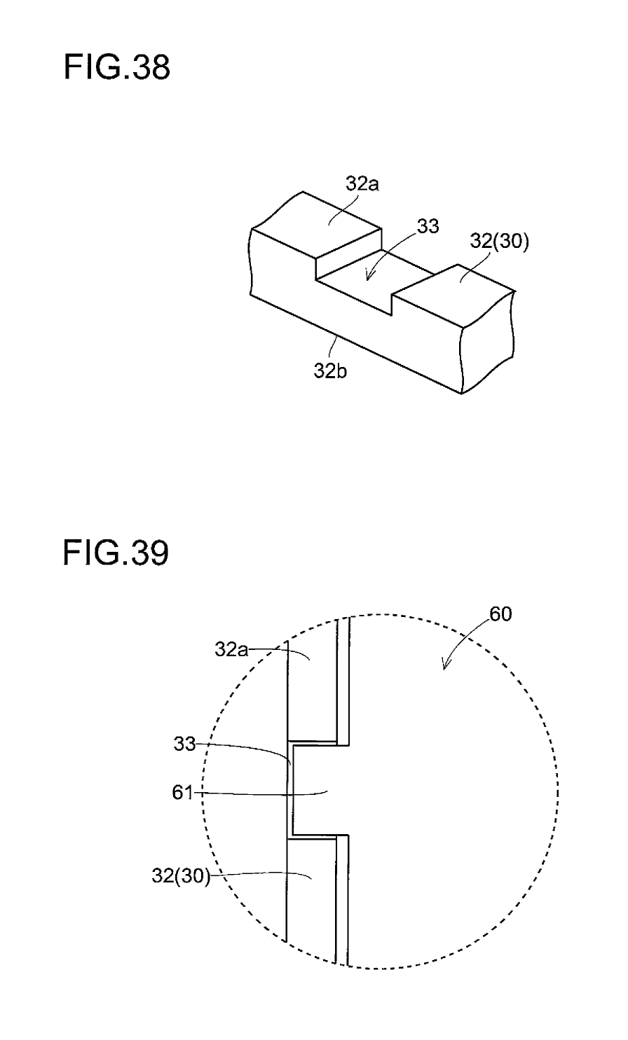

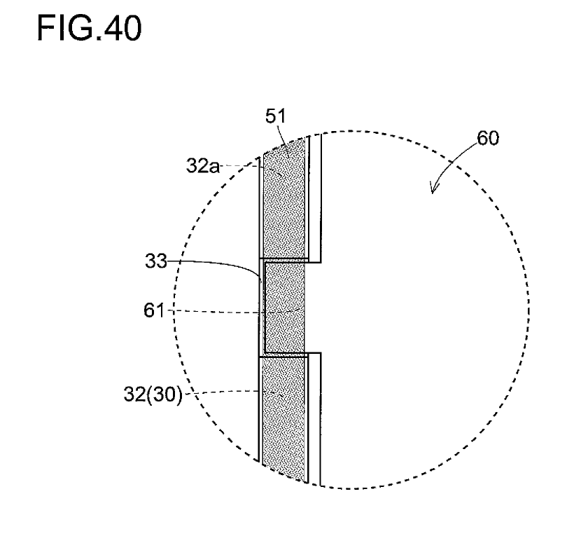

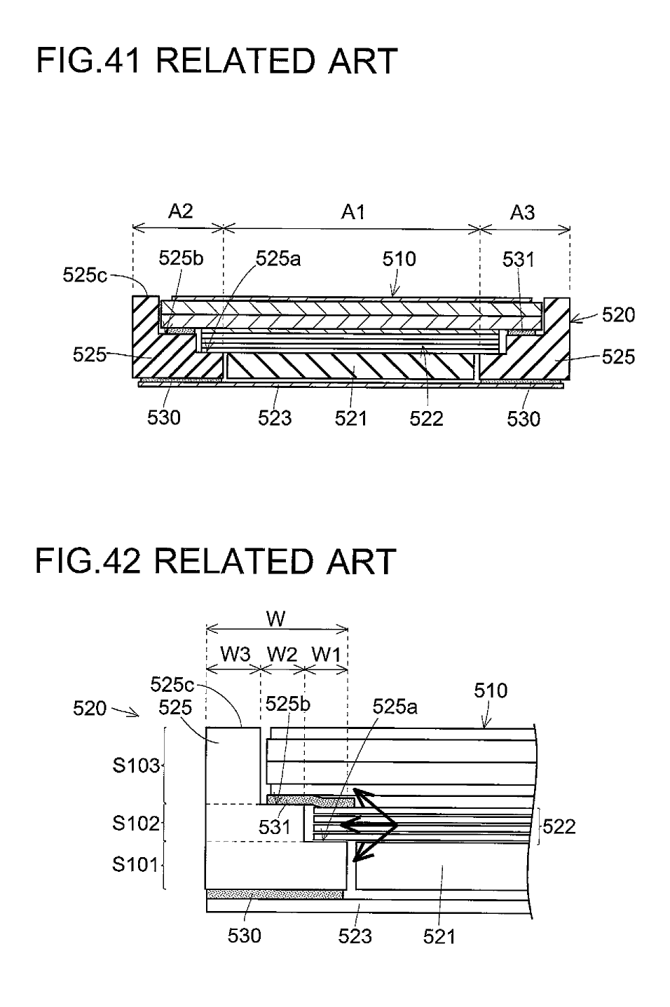

In the second embodiment, the shape of the notches of the frame may be another shape. For example, the shape of the notches 33 of the frame 30 may be a shape such as is illustrated in FIGS. 38 to 40. In such a case, the region of the protrusions 61 covered by the adhesive layer 51 would be larger, and the diffusion sheet 60 and the frame 30 would be more securely fixed (supported).

Embodiments obtained by combining as appropriate the features disclosed above are also encompassed by the technical scope of the present invention.

### LIST OF REFERENCE SIGNS

1 Liquid crystal display device (display device)
10 Liquid crystal display panel (display panel)
11 Active matrix substrate
12 Opposing substrate
13 Polarizing film
20 Backlight unit (illumination device)
21 LEDs (light source)
22 Light guide plate (light guide member)
22a Light emission region
23 Light guide
23a Light incidence surface (light entrance surface)
23b Light emission surface, front surface (upper surface)
23c Rear surface (lower surface)
23d Flat part
23e Prism (first reflective part)
23f Inclined surface
23g Perpendicular surface
23h Flat part
23i Prism (third reflective part)
23j Inclined surface
24 Low-refractive-index layer
24a Rear surface
24b Prism (second reflective part)
25 Prism layer
25a Rear surface
25b Prism (second reflective part)
25c Inclined surface
25d Perpendicular surface
30 Frame (accommodation member)
31 Opening
32 Walls
32a Upper surface
32b Lower surface
33 Notch
40 Reflective sheet
50, 51 Adhesive layer
60 Diffusion sheet
61 Protrusion

1. An illumination device, provided with a light source, a light guide member for guiding light coming from the light source, and an accommodation member for accommodating the light source and the light guide member,
the light guide member comprising a light guide onto which the light coming from the light source is incident, and a low-refractive-index layer provided on a rear surface of the light guide,
the refractive index of the low-refractive-index layer being lower than the refractive index of the light guide,
a plurality of first reflective parts for gradually reducing the angle of incidence of the light coming from the light source with respect to a rear surface of the light guide being provided to a front surface of the light guide or the rear surface thereof,
a plurality of second reflective parts for reflecting forward the light coming from the light source being provided to the rear surface of the light guide member,
the accommodation member comprising a wall for surrounding the light source and the light guide member, and
the width of an upper side of the wall and the width of a lower side thereof being equal.

2. The illumination device as set forth in claim 1, the accommodation member being formed in a frame shape, and a cross-section of the wall of the accommodation member being quadrangular.

3. The illumination device as set forth in claim 1, the height of the wall of the accommodation member being equal to the thickness of the light guide member.

4. The illumination device as set forth in claim 1, the accommodation member comprising a light-blocking resin material.

5. The illumination device as set forth in claim 1, further provided with a diffusion sheet overlapped by the light guide member.

6. The illumination device as set forth in claim 5, the diffusion sheet having an outwardly protruding protrusion as seen in plan view, and the wall of the accommodation member having a notch into which the protrusion of the diffusion sheet is fitted.

7. The illumination device as set forth in claim 5, the size of the diffusion sheet being equal to that of the light guide member.

8. The illumination device as set forth in claim 2, further provided with a reflective sheet disposed on a rear surface side of the light guide member, the frame-shaped accommodation member having an opening in the middle thereof, and the reflective sheet being arranged so as to cover the opening of the accommodation member.

9. A display device provided with the illumination device as set forth in claim 1, and a display panel for receiving light coming from the illumination device.
